(19) United States
(12) Patent Application Publication
(10) Pub. No.: US 2002/0072893 A1
(43) Pub. Date: Jun. 13, 2002

(54) System, method and article of manufacture for using a microprocessor emulation in a hardware application with non time-critical functions

(76) Inventor: Alex Wilson, Oxford (GB)

Correspondence Address: CARLTON FIELDS, P.O. Box 3239, Tampa, FL, 33601-3239, US

(21) Appl. No.: 09/859,051

(22) Filed: May 16, 2001

Related U.S. Application Data
(63) Continuation-in-part of application No. 09/687,481, filed on Oct. 12, 2000.

(51) Int. Cl. G06F 9/455

(52) U.S. Cl. 703/26

(57) ABSTRACT

A system, method and article of manufacture are provided for processing instructions of an embedded application. A microprocessor is emulated in reconfigurable logic. Control functions are also implemented in reconfigurable logic. The emulated microprocessor processes the instructions. Each instruction is processed in a minimum number of clock cycles required for accessing an external instruction and data memory.

### RELATED APPLICATIONS

This application is a continuation in part of U.S. patent application entitled System, Method, and Article of Manufacture for Emulating a Microprocessor in Reconfigurable Logic, Ser. No. 09/687481, filed Oct. 12, 2000, and which is incorporated herein by reference for all purposes.

### FIELD OF THE INVENTION

The present invention relates to emulating microprocessor logic and more particularly to emulating new cores for use in hardware applications with complex but non time-critical functions.

### BACKGROUND OF THE INVENTION

Many producers of instruction sets, or cores, do not manufacture anything tangible. They license microprocessor cores to silicon manufactures. Such silicon manufactures use these cores to create ASSP's (Application Specific Standard Products) and/or ASIC's (Application Specific Integrated Circuits). The licensees typically manufacture devices such as GSM baseband processors, disk drive controllers, engine management controllers, etc. No one manufactures a simple microprocessor that is compatible with newly released cores.

This has two major impacts on core producers. When a core producer releases a new core, potential licensees would like to be able to evaluate the core before committing to buy a multi-million dollar license. Unfortunately, no silicon-based circuits can be made for at least six months from the time that the core is released, so evaluation is based only on the C-programming language model of the core. It is very difficult to create systems around this core and run code on such systems for evaluation purposes. Simulations of such systems only execute code at a rate of less than 10 instructions per second, and therefore cannot be used with real code.

This puts new core producers in an awkward position since they cannot establish their innovative architecture with the technical community. It is impossible to buy a microprocessor reflecting the new core off the shelf from a distributor for testing purposes. This may be the cause of many lost opportunities.

There is thus a need for a service capable of creating instruction-accurate hardware emulations of new cores for testing and verification purposes.

### SUMMARY OF THE INVENTION

A system, method and article of manufacture are provided for processing instructions of an embedded application. A microprocessor is emulated in reconfigurable logic. Control functions are also implemented in reconfigurable logic. The microprocessor emulation processes the instructions. Each instruction is processed in a minimum number of clock cycles required for accessing an external instruction and data memory.

In a preferred embodiment, the reconfigurable logic includes one or more Field Programmable Gate Arrays (FPGAs). Also preferably, macros are used to specify access to resources by the microprocessor.

In another embodiment of the present invention, the control functions control execution of time-critical functions of the application. The time-critical functions of the application can be written in a programming language designed for compiling a programming language to programmable logic and/or in a Hardware Description Language (HDL).

### BRIEF DESCRIPTION OF THE DRAWINGS

The invention will be better understood when consideration is given to the following detailed description thereof. Such description makes reference to the annexed drawings wherein:

FIG. 1 is a flow diagram of a process for emulating a microprocessor according to an embodiment of the present invention;

FIG. 2 is a schematic diagram of a hardware implementation of one embodiment of the present invention;

FIG. 3 is a flow diagram illustrating discrete modules and a data flow of an MP3 decoder according to an embodiment of the present invention;

FIG. 4 illustrates a method for controlling processes of a system according to an embodiment of the present invention;

FIG. 5 is a flow diagram of a process for automatically partitioning a behavioral description of an electronic system into the optimal configuration of hardware and software according to a preferred embodiment of the present invention;

FIG. 6 is a flow diagram schematically showing the codesign system of one embodiment of the invention;

FIG. 7 illustrates the compiler objects which can be defined in one embodiment of the invention;

FIG. 8 is a block diagram of the platform used to implement the second example circuit produced by an embodiment of the invention;

FIG. 9 is a picture of the circuit of FIG. 8;

FIG. 10 is a block diagram of the system of FIG. 8;

FIG. 11 is a simulation of the display produced by the example of FIGS. 8 to 10;

FIG. 12 is a block diagram of a third example target system;

FIGS. 13 A-D together form a block diagram showing a dependency graph for calculation of the variables in the FIG. 12 example; and

FIG. 14 is a diagrammatic overview of a board of a resource management device according to an illustrative embodiment of the present invention.

### DETAILED DESCRIPTION OF THE PREFERRED EMBODIMENTS

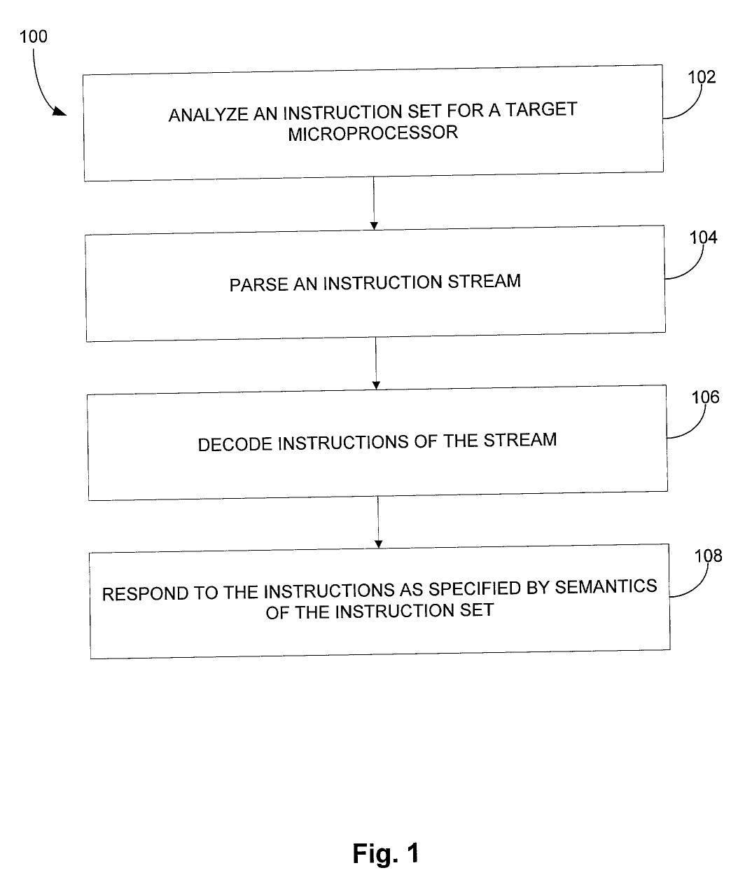

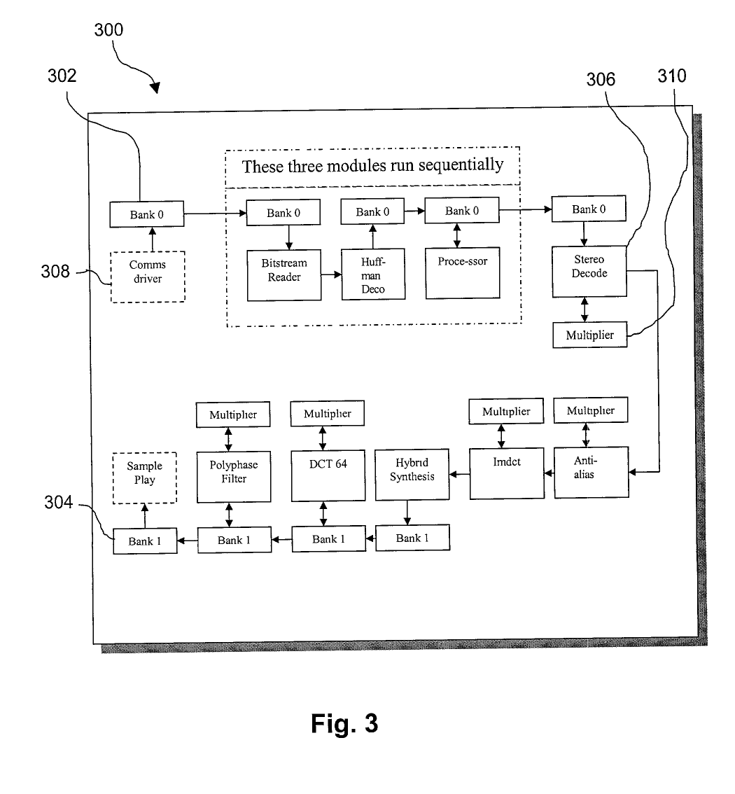

FIG. 1 illustrates a process 100 for emulating a microprocessor. In operation 102, an instruction set for a target microprocessor is analyzed. In operation 104, an instruction stream is parsed. The instructions of the stream are decoded in operation 106. The present invention then responds to the instructions in operation 108 as specified by semantics of the instruction set. See also the section below entitled “MP3 Decoder Example” and the corresponding discussion of FIG. 3.

In one embodiment, the various steps of the present invention are implemented on a reconfigurable logic device such as a Programmable Logic Device (PLD). Such implementation may be carried out for the purpose of analyzing functionality of the microprocessor. As an option, the reconfigurable logic device may include at least one field programmable gate array. Further, the reconfigurable logic device may be cycle-accurate with respect to the target microprocessor.

In various embodiments of the present invention, the reconfigurable logic device is configured for one or more of the following: emulation of a micro-instruction architecture, emulation of a pipelining system, emulation of a superscalar architecture, register renaming with internal registers, and/or out-of-order execution of independent instruction sequences.

A pipeline is the continuous and somewhat overlapped movement of instruction to the processor or in the arithmetic steps taken by the processor to perform an instruction. Pipelining is the use of a pipeline. Without a pipeline, a computer processor gets the first instruction from memory, performs the operation it calls for, and then goes to get the next instruction from memory, and so forth. While fetching (getting) the instruction, the arithmetic part of the processor is idle. It waits until it gets the next instruction. With pipelining, the computer architecture allows the next instructions to be fetched while the processor is performing arithmetic operations, holding them in a buffer close to the processor until each instruction operation can be performed. The staging of instruction fetching is continuous. The result is an increase in the number of instructions that can be performed during a given time period.

The processor pipelining according to an embodiment of the present invention can be divided into an instruction pipeline and an arithmetic pipeline. The instruction pipeline represents the stages in which an instruction is moved through the processor, including its being fetched, perhaps buffered, and then executed. The arithmetic pipeline represents the parts of an arithmetic operation that can be broken down and overlapped as they are performed.

Pipelines and pipelining according to the parent invention may also apply to computer memory controllers and moving data through various memory staging places.

In one embodiment of the present invention, the instruction set which the microprocessor will implement may be analyzed, as set forth hereinabove. A program may be written to parse the instruction stream. Such program may also decode the instructions in the stream [in the instruction set] and respond to the instructions as specified by the semantics of the instruction set.

The present invention thus allows the testing and verification of the microprocessor using a program written in the instruction set of the target microprocessor, thus providing for an iterative build, test and debugging cycle. This process implemented on a reconfigurable logic device results in a faster and reduced development cycle which is more cost efficient, and uses fewer development resources.

In another embodiment of the present invention, there may be two alternatives for analyzing the required functionality of the microprocessor. The first may include observing the behavior of an existing instruction set by writing or using a program and/or to research the relevant documentation. The second may include the development of a new instruction set.

This second method may comprise determining what the processor's functionality is to be and identifying and creating the necessary instructions, operands and I/O semantics. Thereafter, a theory of operation for each instruction and the appropriate I/O mechanisms.

The present invention provides a processor core that executes a subset of an instruction set for testing and verification purposes. In order to test such a “soon-to-be-manufactured” microprocessor, a limited-function microprocessor core of the present invention may be used that could be utilized in combination with some standard software development tools. The core may be created using a subset of the microprocessor instruction set. In one example, an ARM microprocessor instruction set may be employed, as set forth in “Computers and Microprocessors” (by A C Downton, published by Chapman & Hall), which is herein incorporated by reference. While it need not necessarily be cycle-accurate or architecturally similar, it may serve for the purpose of demonstration.

The present invention thus provides a service to create instruction-accurate hardware emulations of new cores, implemented in programmable logic, i.e. FPGA(s), as soon as the instruction set is defined, with cycle-accurate models following shortly after the C-programming language models are released. This is very valuable to producers of new cores, enabling them to perform internal evaluations and benchmarking, based on real code, running at sensible speeds. Some speeds may be greater or less than a quarter of the speed of the final product, before the core is launched. The present invention enables such core producers to offer a system level hardware emulation to their potential licensees. Such emulations could lead to a volume opportunity that would be serviced by a licensee, with the resulting royalty benefits to the core producer. As an option, the support issues may be handled by a third party.

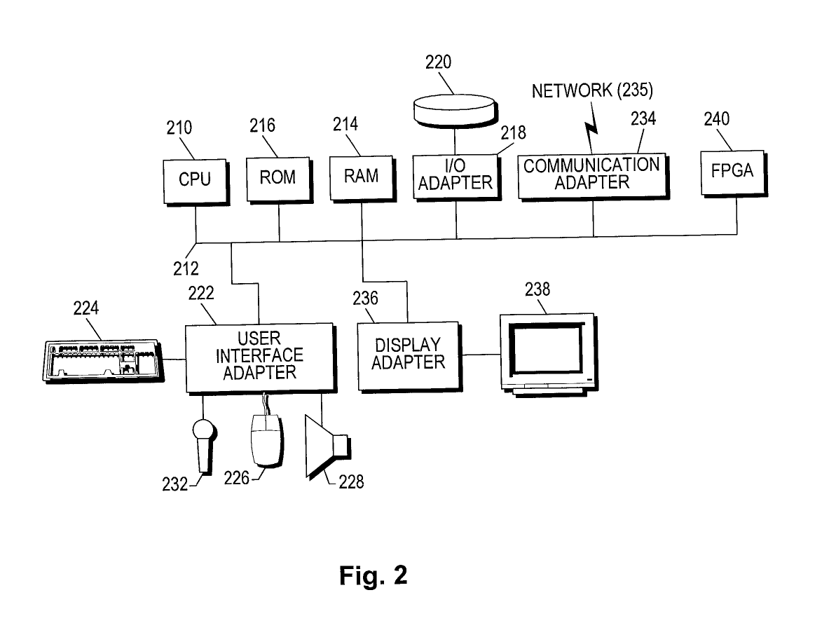

A preferred embodiment of a system in accordance with the present invention is preferably practiced in the context of a personal computer such as an IBM compatible personal computer, Apple Macintosh computer or UNIX based workstation. A representative hardware environment is depicted in FIG. 2, which illustrates a hardware configuration of a workstation in accordance with a preferred embodiment having a central processing unit 210, such as a reconfigurable logic device, including an FPGA or multiple FPGAs, that performs the functions of a microprocessor, and a number of other units interconnected via a system bus 212. The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network (e.g., a data processing network) and a display adapter 236 for connecting the bus 212 to a display device 238. The workstation can also include a memory device (not shown) and/or an FPGA 240 with a complete or a portion of an operating system thereon such as the Microsoft Windows NT or Windows/98 Operating System (OS), the IBM OS/2 operating system, the MAC OS, or UNIX operating system. Those skilled in the art will appreciate that the present invention may also be implemented on platforms and operating systems other than those mentioned.

In a preferred embodiment, the reconfigurable logic device of the present invention includes Complex PLD's or CPLD's. Such devices are included in the Advanced Micro Devices MACH.TM. family. Examples of CPLD circuitry are seen in U.S. Pat. No. 5,015,884 (issued May 14, 1991 to Om P. Agrawal et al.) and U.S. Pat. No. 5,151,623 (issued Sep. 29, 1992 to Om P. Agrawal et al.), which are herein incorporated by reference.

Another preferred embodiment of the present invention includes Field Programmable Gate Arrays or FPGA's. Examples of such devices include the XC2000.TM. and XC3000.TM. families of FPGA devices introduced by Xilinx, Inc. of San Jose, Calif. The architectures of these devices are exemplified in U.S. Pat. Nos. 4,642,487; 4,706,216; 4,713,557; and 4,758,985; each of which is originally assigned to Xilinx, Inc. and which are incorporated by reference for all purposes.

An FPGA device can be characterized as an integrated circuit that has four major features as follows.

(1) A user-accessible, configuration-defining memory means, such as SRAM, PROM, EPROM, EEPROM, anti-fused, fused, or other, is provided in the FPGA device so as to be at least once-programmable by device users for defining user-provided configuration instructions. Static Random Access Memory or SRAM is of course, a form of reprogrammable memory that can be differently programmed many times. Electrically Erasable and reProgrammable ROM or EEPROM is an example of nonvolatile reprogrammable memory. The configuration-defining memory of an FPGA device can be formed of mixture of different kinds of memory elements if desired (e.g., SRAM and EEPROM) although this is not a popular approach.

(2) Input/Output Blocks (IOB's) are provided for interconnecting other internal circuit components of the FPGA device with external circuitry. The IOB's may have fixed configurations or they may be configurable in accordance with user-provided configuration instructions stored in the configuration-defining memory means.

(3) Configurable Logic Blocks (CLB's) are provided for carrying out user-programmed logic functions as defined by user-provided configuration instructions stored in the configuration-defining memory means.

Each of the many CLB's of an FPGA has at least one lookup table (LUT) that is user-configurable to define any desired truth table-to the extent allowed by the address space of the LUT. Each CLB may have other resources such as LUT input signal pre-processing resources and LUT output signal post-processing resources. Although the term ‘CLB’ was adopted by early pioneers of FPGA technology, it is not uncommon to see other names being given to the repeated portion of the FPGA that carries out user-programmed logic functions. The term, ‘LAB’ is used for example in U.S. Pat. No. 5,260,611 to refer to a repeated unit having a 4-input LUT.

(4) An interconnect network is provided for carrying signal traffic within the FPGA device between various CLB's and/or between various IOB's and/or between various IOB's and CLB's. At least part of the interconnect network can be configurable so as to allow for programmably-defined routing of signals between various CLB's and/or IOB's in accordance with user-defined routing instructions stored in the configuration-defining memory means.

In some instances, FPGA devices may additionally include embedded volatile memory for serving as scratchpad memory for the CLB's or as FIFO or LIFO circuitry. The embedded volatile memory may be fairly sizable and can have 1 million or more storage bits in addition to the storage bits of the device's configuration memory.

Modern FPGA's tend to be fairly complex. They typically offer a large spectrum of user-configurable options with respect to how each of many CLB's should be configured, how each of many interconnect resources should be configured, and/or how each of many IOB's should be configured. This means that there can be thousands or millions of configurable bits that may need to be individually set or cleared during configuration of each FPGA device.

A computer and appropriate FPGA-configuring software can be used to automatically generate the configuration instruction signals that will be supplied to, and that will ultimately cause an unprogrammed FPGA to implement a specific design. (The configuration instruction signals may also define an initial state for the implemented design, that is, initial set and reset states for embedded flip flops and/or embedded scratchpad memory cells.)

The number of logic bits that are used for defining the configuration instructions of a given FPGA device tends to be fairly large (e.g., 1 Megabits or more) and usually grows with the size and complexity of the target FPGA. Time spent in loading configuration instructions and verifying that the instructions have been correctly loaded can become significant, particularly when such loading is carried out in the field.

For many reasons, it is often desirable to have in-system reprogramming capabilities so that reconfiguration of FPGA's can be carried out in the field.

FPGA devices that have configuration memories of the reprogrammable kind are, at least in theory, ‘in-system programmable’ (ISP). This means no more than that a possibility exists for changing the configuration instructions within the FPGA device while the FPGA device is ‘in-system’ because the configuration memory is inherently reprogrammable. The term, ‘in-system ’ as used herein indicates that the FPGA device remains connected to an application-specific printed circuit board or to another form of end-use system during reprogramming. The end-use system is of course, one which contains the FPGA device and for which the FPGA device is to be at least once configured to operate within in accordance with predefined, end-use or ‘in the field’ application specifications.

The possibility of reconfiguring such inherently reprogrammable FPGA's does not mean that configuration changes can always be made with any end-use system. Nor does it mean that, where in-system reprogramming is possible, that reconfiguration of the FPGA can be made in timely fashion or convenient fashion from the perspective of the end-use system or its users. (Users of the end-use system can be located either locally or remotely relative to the end-use system.)

Although there may be many instances in which it is desirable to alter a pre-existing configuration of an ‘in the field’ FPGA (with the alteration commands coming either from a remote site or from the local site of the FPGA), there are certain practical considerations that may make such in-system reprogrammability of FPGA's more difficult than first apparent (that is, when conventional techniques for FPGA reconfiguration are followed).

Another class of FPGA integrated circuits (IC's) relies on volatile memory technologies such as SRAM (static random access memory) for implementing on-chip configuration memory cells. The popularity of such volatile memory technologies is owed primarily to the inherent reprogrammability of the memory over a device lifetime that can include an essentially unlimited number of reprogramming cycles.

There is a price to be paid for these advantageous features, however. The price is the inherent volatility of the configuration data as stored in the FPGA device. Each time power to the FPGA device is shut off, the volatile configuration memory cells lose their configuration data. Other events may also cause corruption or loss of data from volatile memory cells within the FPGA device.

Some form of configuration restoration means is needed to restore the lost data when power is shut off and then re-applied to the FPGA or when another like event calls for configuration restoration (e.g., corruption of state data within scratchpad memory).

The configuration restoration means can take many forms. If the FPGA device resides in a relatively large system that has a magnetic or optical or opto-magnetic form of nonvolatile memory (e.g., a hard magnetic disk)—and the latency of powering up such a optical/magnetic device and/or of loading configuration instructions from such an optical/magnetic form of nonvolatile memory can be tolerated—then the optical/magnetic memory device can be used as a nonvolatile configuration restoration means that redundantly stores the configuration data and is used to reload the same into the system's FPGA device(s) during power-up operations (and/or other restoration cycles).

On the other hand, if the FPGA device(s) resides in a relatively small system that does not have such optical/magnetic devices, and/or if the latency of loading configuration memory data from such an optical/magnetic device is not tolerable, then a smaller and/or faster configuration restoration means may be called for.

Many end-use systems such as cable-TV set tops, satellite receiver boxes, and communications switching boxes are constrained by prespecified design limitations on physical size and/or power-up timing and/or security provisions and/or other provisions such that they cannot rely on magnetic or optical technologies (or on network/satellite downloads) for performing configuration restoration. Their designs instead call for a relatively small and fast acting, non-volatile memory device (such as a securely-packaged EPROM IC), for performing the configuration restoration function. The small/fast device is expected to satisfy application-specific criteria such as: (1) being securely retained within the end-use system; (2) being able to store FPGA configuration data during prolonged power outage periods; and (3) being able to quickly and automatically re-load the configuration instructions back into the volatile configuration memory (SRAM) of the FPGA device each time power is turned back on or another event calls for configuration restoration.

The term ‘CROP device’ will be used herein to refer in a general way to this form of compact, nonvolatile, and fast-acting device that performs ‘Configuration-Restoring On Power-up’ services for an associated FPGA device.

Unlike its supported, volatilely reprogrammable FPGA device, the corresponding CROP device is not volatile, and it is generally not ‘in-system programmable’. Instead, the CROP device is generally of a completely nonprogrammable type such as exemplified by mask-programmed ROM IC's or by once-only programmable, fuse-based PROM IC's. Examples of such CROP devices include a product family that the Xilinx company provides under the designation ‘Serial Configuration PROMs’ and under the trade name, XC1700D.TM. These serial CROP devices employ one-time programmable PROM (Programmable Read Only Memory) cells for storing configuration instructions in nonvolatile fashion.

A preferred embodiment is written using Handel-C, a programming language developed from Handel. Handel was a programming language designed for compilation into custom synchronous hardware, which was first described in “Compiling occam into FPGAs”, Ian Page and Wayne Luk in “FPGAs” Eds. Will Moore and Wayne Luk, pp 271-283, Abingdon EE & CS Books, 1991, which are herein incorporated by reference. Handel was later given a C-like syntax (described in “Advanced Silicon Prototyping in a Reconfigurable Environment”, M. Aubury, I. Page, D. Plunkett, M. Sauer and J. Saul, Proceedings of WoTUG 98, 1998, which is also incorporated by reference), to produce various versions of Handel-C.

Handel-C is a programming language marketed by Celoxica Limited, 7-8 Milton Park, Abingdon, Oxfordshire, OX14 4RT, United Kingdom. It enables a software or hardware engineer to target directly FPGAs (Field Programmable Gate Array) in a similar fashion to classical microprocessor cross-compiler development tools, without recourse to a Hardware Description Language, thereby allowing the designer to directly realize the raw real-time computing capability of the FPGA.

Handel-C is designed to enable the compilation of programs into synchronous hardware; it is aimed at compiling high level algorithms directly into gate level hardware.

The Handel-C syntax is based on that of conventional C so programmers familiar with conventional C will recognize almost all the constructs in the Handel-C language. More information regarding the Handel-C programming language may be found in “EMBEDDED SOLUTIONS Handel-C Language Reference Manual: Version 3,” “EMBEDDED SOLUTIONS Handel-C User Manual: Version 3.0,” “EMBEDDED SOLUTIONS Handel-C Interfacing to other language code blocks: Version 3.0,” each authored by Rachel Ganz, and published by Celoxica Limited in the year of 2001; and “EMBEDDED SOLUTIONS Handel-C Preprocessor Reference Manual: Version 2.1,” also authored by Rachel Ganz and published by Embedded Solutions Limited in the year of 2000; and which are each incorporated herein by reference in their entirety. Also, United States Patent Application entitled SYSTEM, METHOD AND ARTICLE OF MANUFACTURE FOR INTERFACE CONSTRUCTS IN A PROGRAMMING LANGUAGE CAPABLE OF PROGRAMMING HARDWARE ARCHITECTURES and assigned to common assignee Celoxica Limited provides more detail about programming hardware using Handel-C and is herein incorporated by reference in its entirety for all purposes.

Sequential programs can be written in Handel-C just as in conventional C but to gain the most benefit in performance from the target hardware its inherent parallelism must be exploited.

Handel-C includes parallel constructs that provide the means for the programmer to exploit this benefit in his applications. The compiler compiles and optimizes Handel-C source code into a file suitable for simulation or a netlist which can be placed and routed on a real FPGA.

It should be noted that other programming and hardware description languages can be utilized as well, such as VHDL.

Another embodiment is written using JAVA, C, and the C++ language and utilizes object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. A preferred embodiment of the invention utilizes HyperText Markup Language (HTML) to implement documents on the Internet together with a general-purpose secure communication protocol for a transport medium between the client and the Newco. HTTP or other protocols could be readily substituted for HTML without undue experimentation. Information on these products is available in T. Berners-Lee, D. Connoly, “RFC 1866: Hypertext Markup Language -2.0” (November 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystem's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

Another technology that provides similar function to JAVA is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for JAVA without undue experimentation to practice the invention.

Processor Module

An embodiment of the present invention provides a virtual processor module as a new architectural solution using a reconfigurable programmable logic device, such as the FPGA, for processing complex applications. The virtual processor module, in accord with the present invention, facilitates dividing complex operations into a series of simpler operations that are optimized in accord with a design strategy for performance and use of resources for execution by a reconfigurable programmable logic device that is dynamically modified by a processor through partial or complete reconstruction of its internal resources transparently to the operation of the rest of the system.

In accord with the present invention, a virtual processor comprises a programmable logic device capable of being configured to perform a plurality of different operations, means for providing a plurality of configuration files, each file for configuring the programmable logic device for performing a specific operation, and a controller for providing configuration files to the programmable logic device in an appropriate sequence for performing a complex operation.

A preferred virtual processor, in accord with the present invention, comprises the following components: a reconfigurable, programmable logic matrix array for processing data in accord with a hardware encoded algorithm; a memory for storing a plurality of hardware configuration files for the programmable logic matrix array, each configuration file for programming an algorithm to be executed by the matrix array; an input/output bus for supplying data to the matrix array for processing and for obtaining processed data from the matrix array; a memory device for storing data; a VPM controller for controlling the overall operation of the virtual processor including providing operation sequence maps, providing parameters for specific operations, and providing status information; a data bus controller for controlling the data flow to the matrix array for processing; and a configuration controller for controlling the sequence of reconfiguration of the matrix array to process data by a specific sequence of algorithms.

In accord with one embodiment of the present invention, a virtual processor module is provided whereby a complex operation can be divided into a series of simpler operations where each simple operation is executed by a particular configuration provided in the appropriate sequence to accomplish the complex operation through partial or complete dynamic reconstruction of the processor resources transparently to the operation of the rest of the system and to the user.

A virtual processor module in accord with the present invention can replace a number of modules, each efficiently designed for an execution of a particular function and connected with each other by a number of data busses for pipeline simultaneous processing, therefore, allowing significant savings in product cost, size and power consumption.

A virtual processor module in accord with the present invention can allow a user to modify and expand its functionality while achieving custom hardware performance level as provided by the reconfigurable programmable logic device such as a FPGA, but without any modifications to the processor hardware.

In one embodiment of the invention, upon a fault detection, the virtual processor module can reconfigure itself to provide full functionality at half the processing rate.

In another preferred embodiment of the invention, the virtual processor module uses a programmable real-time microcontroller to control programming, status verification and parameter interaction of a dynamically reconfigurable programmable logic device that is connected to input/output data busses and to internal data and parameter storage devices. The virtual processor module includes means for storing locally or accessing a library of configuration files necessary for programming the reconfiguration of the programmable logic device. Using the library of configuration files, a complex function request is performed by executing a number of simpler sub-functions, by queuing the configuration files into an appropriate sequence for their execution parameters and by controlling the programmable logic device through their executions. The real-time interaction of the programmable logic device and the controller, which provides parameter and status communications from configuration to configuration, creates a continuous processing of data to perform the required functionality for the complex operation. Preferably, means for fault detection of errors in a portion of the programmable logic device are provided and recovery of functionality is achieved through process reorganization using the remainder of the programmable logic device to provide full functionality at a reduced rate of operation.

In certain preferred embodiments of the invention, the programmable logic device is provided as two or more programmable processing elements (PPEs), each connected to the controller, I/O data buses and internal storage devices. More preferably, there are an even number of PPEs, provided in a symmetrical arrangement.

In another preferred embodiment of the invention, the programmable logic device consists of scalable, from one to four, field programmable gate arrays interconnected for data exchange, and access to parameter and status information storage. The means for programming, control and status reconfiguration flow preferably includes a microcontroller executing a real-time multitasking kernel with the resources for storage of a microcontroller execution program and of the configuration files for a field programmable logic device (e.g., FPGA), and a configuration controller connected with loop-cache memory for storing multiple configuration files. The means for data storage may include a number of data banks connected, preferably in a symmetrical arrangement, to each of the FPGAs through bus controllers and switches.

In a preferred embodiment of the present invention, a virtual processor module comprises: a programmable matrix array for processing data according to a hardware encoded algorithm; a plurality of local memory devices connected to the programmable matrix array for storage of the data processing parameters, processing results, control and status information; a plurality of data memory devices for storing data before, during and after processing by the programmable matrix array; a plurality of data bus controller and switch devices, responsive to the programmable matrix array, for addressing data stored in the data memory devices and for directing said data to and from the programmable matrix array; an I/O bus controller for routing outside data buses to multiple points within programmable matrix array and for delivering data to and from external sources; a plurality of configuration memories for storage of configuration files for configuring the programmable matrix array with hardware encoded algorithms; a plurality of configuration controllers, one for controlling each said configuration memory according to an operation sequence map; and a VPM controller for interaction with an external host, for sequencing configuration files to create an operation sequence map and loading the files into the configuration memories, for programming configuration controllers, for communicating with the programmable array matrix and delivering control information and parameters necessary for data processing from the local memory devices, and for reading results of the processing and status information; wherein an execution of a complex operation can be achieved by dividing it into a series of simpler operations, each executable by a configuration file provided to the programmable matrix array through partial or complete reconfiguration, transparently to the user.

The present invention also provides methods for processing data by executing complex operations by using a series of simpler operations, each of which can be configured in a programmable processing element to process the data in a series of configurations. Thus, in one embodiment of the invention, a method for processing data for a specific application comprises: providing a reconfigurable, programmable logic matrix array comprising two programmable processing elements under the control of a real time multitasking processor; providing a plurality of configuration files, each file for configuring the logic matrix array to perform an algorithm for processing data; sequencing a plurality of configuration files to perform a complex operation and for preparing an operation sequence map to control the configuration of the logic matrix array in said sequence; providing a sequence operation map and a sequence of configuration files to configure each programmable processing element to process data in accord with the respective sequence maps; configuring the two programmable processing elements with a first configuration for each programmable processing element and processing data with the two programmable processing elements in a synchronous mode; and for each programmable processing element, after the data is processed by one configuration of the element, reconfiguring the element with the next configuration file in the sequence and continuing to process data until the operation sequence map is completed for both of the two elements.

When the operation sequence map for each programmable processing element contains the same number of configuration files, the first configuration for both elements can be configured synchronously and data can be processed in both elements synchronously, and each subsequent configuration for the two elements can be configured in parallel and operated synchronously so that each of the two elements completes its operation processing sequence at substantially the same time.

When the operation sequence map for each programmable processing element contains a different number of configuration files, one or more pairs of configuration files consisting of a configuration file from each operation sequence map can be designated as a locked pair to be configured in its respective processing element at the same time as the matching configuration file of the pair is configured in its processing element so that data can be processed simultaneously by the elements in accord with designated locked configurations configured by the locked pair, each element being reconfigured in accord with the configuration files in its respective operation sequence map and processing data independently for configurations in the sequence between the configuration files designated as a locked pair.

In another embodiment of the invention, a method for processing data for a specific application comprises: providing a reconfigurable, programmable logic matrix array comprising two programmable processing elements under the control of a real time multitasking processor; providing a plurality of configuration files, each file for configuring a programmable processing element to perform an algorithm for processing data; sequencing a plurality of configuration files to perform a complex operation and for preparing an operation sequence map to control the configuration of each processing element in accord with said sequence; providing a sequence operation map and a sequence of configuration files to alternately configure each programmable processing element to process data in accord with the sequence map; configuring a first programmable processing element with a configuration; configuring the second programmable processing element with its first configuration while processing data with the first processing element; and, alternately, configuring a first programmable processing element with a configuration while processing data with the second programmable processing element and, then, configuring the second programmable processing element with a configuration while processing data with the first programmable processing element until the operation sequence map is completed for the two processing elements.

The method for processing data can also include a fault detection and recovery mode. When a fault is detected in the processing of one of the processing elements, the method includes: reconstructing the sequence of configuration files to operate on the other processing element and reconstructing the sequence operation map accordingly; and continuing to alternately reconfigure the other processing element and then process data with that processing element until the operation sequence map is completed on that processing element.

In another embodiment of the invention, a method for processing data for a specific application comprises: providing a reconfigurable, programmable logic matrix array under the control of microprocessor, preferably operating a multitasking real-time kernel; providing a library of configuration files, each file for configuring the logic matrix array to perform an algorithm for processing data; sequencing a first plurality of configuration files to perform a complex operation and for preparing an operation sequence map to control the configuration of the logic matrix array in said sequence; providing a operation sequence map to configure the logic matrix array to process data in accord with the sequence of configuration files specified by the operation sequence map; configuring the logic matrix array with a first configuration file and processing data in accord with the algorithm provided by the first configuration file and, after the data is processed by one configuration file, reconfiguring the logic matrix array with the next configuration file in the operation sequence map and continuing to process data until a programmed criteria is satisfied, thereby generating a configuration dependent operational event signal; obtaining a next configuration opcode from the logic matrix array in response to the configuration dependent operational event signal; locating a second plurality of configuration files in the library which are identified by the next configuration opcode; sequencing the second plurality of configuration files and preparing a second operation sequence map for the second plurality of configuration files; and configuring the logic matrix array with the second plurality of configuration files in accord with the second operation sequence map to continue processing data.

Multiprocessor Embodiments

In one embodiment, the present invention is a multiprocessor comprising a multidimensional array of FPGAs, each FPGA having local memory; a process controller, connected to the array of FPGAs; and an input/output (I/O) controller, connected to the array of FPGAs and to the process controller. The array of FPGAs is adapted to be programmed as one or more processing elements (PEs), the process controller is adapted to control processing implemented by the PEs, and the I/O controller is adapted to control data flow into and out of the PEs and the process controller.

In another embodiment, the invention is a multiprocessor comprising a first FPGA and one or more other FPGAs, connected to the first FPGA. The first FPGA is adapted to be programmed to function exclusively as a process controller for the one or more other FPGAs and the one or more other FPGAs are adapted to be programmed to function exclusively as processing elements.

In one embodiment, the multiprocessor of the present invention is based on a multidimensional array of field programmable gate arrays (FPGAs) adapted to be programmed to function as one or more processing elements (PEs). Each FPGA in the array preferably has its own local memory and can be programmed to use the same local-memory addresses as the other FPGAs in the array.

In a one-dimensional array of FPGAs, each FPGA is connected to either one or two neighboring FPGAs. In a one-dimensional torroidal array, each FPGA is connected to exactly two neighboring FPGAs. If, in an array of FPGAs, at least one FPGA is connected to at least three neighboring FPGAs, then that array is said to be a multidimensional array (that is, an array of dimension greater than one). In a two-dimensional torroidal array, for example, each FPGA is connected to four neighboring FPGAs. A multidimensional array may have more than two dimensions.

MP3 Decoder Example

This section describes an MP3 core for a stand-alone multimedia board. The implementation can be constructed using several freeware open-source software decoders and as such can contain a mixture of different optimizations. Most of these can be re-written to take advantage of the parallelism implicit in Handel-C.

Features

Full MPEG 1 audio layer III compliance.

Real-time decoding of all bitstreams.

Simple interface.

Low clock rate (8 Mhz) for low power consumption.

MPEG Audio Compression

The full name for MP3 compression is MPEG 1 Layer III compression. It is the third and most advanced of the audio compression formats available for MPEG encoded multimedia data.

MP3 is a lossy compression format, based on the acoustic properties of the human ear. In brief, it transforms an input audio signal into the frequency domain and then using a number of properties of human hearing, it is able to discard a significant proportion of data without a listener perceiving any change thus massively reducing storage space.

The compression process involves a number of steps: Firstly the audio data is sampled, and transformed via filter banks into the frequency domain. This frequency data is then quantized and redundant data discarded using an appropriate psychoacoustic model. After this the resulting data is compressed further using Huffman encoding and encoded into a fixed rate bitstream depending upon the compression rate chosen. Typical compression ratios for MP3 are 8-10 times that of the original raw sample data, making it a perfect format for distribution of music over the Internet.

The MP3 Decoder Algorithms

Decoding and playing MP3 is the reverse of the encoding process. The decoder implemented has eight identifiable stages in producing the final audio signal. These are split between pure hardware implementations, and some software on a lightweight embedded RISC processor core (implemented in HandelC). They are: Bitstream reader, Bitstream Interpreter, Huffman Decoder, Dequantiser, Stereo Decoding, Antialiasing, IMDCT, Polyphase filter bank.

Brief details of their function are outlined below:

Bitstream Reader

The bitstream reader is implemented in hardware, to allow one bitstream read to be implemented per clock cycle. Between 1 and 32 bits can be written per call.

Bitstream Interpreter

The code for parsing the bitstream, extracting information about the frame currently being decoded etc. is handled by the processor core. This code extracts information such as sample frequency, bitrate of the bitstream, stereo encoding method and the Huffman tables to use for extracting the audio data.

Huffman Decoder

The Huffman decoder for MP3 is implemented with a number of fixed tables, optimised for maximum compression of the audio data. The decoder is implemented in hardware, controlled by the processor. It in turn uses the bitstream reading hardware.

Dequantiser

The dequantiser takes the quantized frequency band output from the Huffman decoder, and along with scaling information encoded in the frame side-information, scales (using a large look-up table) the data into a floating-point form. This is implemented in software on the processor

Stereo Decoding

The stereo decoding algorithm takes the dequantized frame information from the processor memory bank, converts it from floating point to fixed point and decodes Mixed-Stereo signals for the filter banks.

IMDCT

A bank of IMDCT (Inverse Modified Discrete Cosine Transform) filters is used to transform the frequency data into an intermediate form before the final polyphase filtering stage.

Polyphase Filter Bank

The polyphase filter bank takes the IMDCT output and transforms the intermediate frequency data into the final sample. This is the most multiply intensive of the transformations and so has a heavily optimised algorithm.

Decoder Architecture

FIG. 3 depicts a system architecture 300 of the exemplary MP3 decoder according to an embodiment of the present invention. The MP3 player uses the following shared resources:

Memory banks 0 and 1 (302, 304)

Audio chip 306

Shared pins between the two FPGAs

Touch screen driver 308

One fixed-point multiplier on the FPGA 310.

The player in this example has been designed so that most of the modules run in parallel in a pipeline. However there are limited resources available to be shared between these various processes. Thus a locking system has been implemented using mutual exclusion processes and the resources partitioned carefully amongst the competing processes. The bitstream reading, Huffman decoding, processor and stereo decoding have been allocated to Memory Bank 0.

The locking on Bank 0 has been designed so that the resource is automatically granted to the processor unless the other processes specifically request it. To implement this, the processor has a halt signal, so that it can run continuously until the memory is requested by one of the three other processes. The next time the processor tries to fetch a new instruction it stops, signals that it is halted and the resource lock is granted to the waiting process. On completion of the process, the halt signal is unset and the processor continues.

The filter banks require both scratch space and multiplication resources and thus both compete for Bank 1 and the multiplier.

The processor is in overall control of the hardware, deciding what parameters to pass to the filter banks and the Huffman decoder. In order to pass data to and from the various other processes, the hardware has been mapped into the address space above the physical memory (1 Meg). The hardware control logic include 16 32-bit registers, which can be used to supply parameters to the hardware, or read back data from the hardware (for instance—the Huffman tables to use for a particular frame are passed to the hardware through some these status registers, and the total number of bits read while decoding returned in another register for the processor to read). Control logic for the hardware has also been mapped into a number of addresses. Thus to start the Huffman decoding process, the processor writes to the appropriate address and then is stalled until decoding completes. Similarly the processor writes to another address to start the filter banks, but as these can run simultaneously (not having any resources in common with which to conflict), the processor can continue immediately the start signal is sent.

The example code below shows the implementation of the memory-mapped hardware control.

// Sixteen 32-bit registers for sending data to and from the hardware
ram unsigned 32 report[16] with {warn = 0};
// Macro to memory map the Hardware registers into the ARM
// address space
macro expr ARMreadmem(reada) =

(reada < MAX_MEM_ADDR) ? ARMram(reada) : report[reada<−4];

// ARM hardware mapped above physical memory
macro proc ARMhardwarewrite( hardaddr, val ) {

halted_BANK0 = 1;
if ( hardaddr[8] ) {

report[ hardaddr<−4] = val;

}
else {

switch ( hardaddr<−9 ) {
case FILL_BUFFER:

cFillBuffer ! (val<−13);
cFillBuffer ! 0;
break;

case PEEK_DATASTREAM:

bits_req!read_stream( val<−5, DATA_BUFFER,
PEEK_BUFFER );
bits_req?report[PEEK_DATASTREAM];
break;

case READ_DATASTREAM:

bits_req!read_stream( val<−5, DATA_BUFFER,
READ_BUFFER );
bits_req?report[READ_DATASTREAM];
break;

case READ_HEADERSTREAM:

bits_req!read_stream( val<−5, HEADER_BUFFER,
READ_BUFFER);
bits_req?report[READ_HEADERSTREAM];
break;

case HUFFMAN_DECODE:

// Start the huffman decode hardware
delay;
decode_huffman_data();
break;

case RUN_FILTERS:

// Start the filter hardware
HardwareStart ! 0;
HardwareStart ! 0;
break;

case DEBUG:

delay;
WriteErrorData( PID_ARM, val<−16);
break;

case READ_TIMER:

report[0] = Timer Counter;
break;

default:

delay;
break;

}

}
halted_BANK0 = 0;

}

As well as the hardware (FPGA configuration) for the decoder, there is also an amount of code for the processor which must be loaded into the flash memory. Processing has been partitioned between the hardware and the processor according to two criteria. Firstly, some code is written for the processor because it is control-heavy but does not need to run particularly fast (thus saving space on the FPGA) but also some code has been partitioned onto the processor so that, with minor changes to the program code, the decoder can be changed so that it can handle MPEG2 audio streams—and thus be used in conjuction with a video decoder for full movie playing.

Usage

The MP3 decoder core is designed to occupy one FPGA on the multimedia board, and to receive commands and bitstream data from another FPGA via communications implemented on the shared pins.

When the MP3 decoder starts up, it performs internal initialization, and then sends a request for program code to the other FPGA.

Having done this, it then does nothing until a command is sent. On receipt of a PLAY instruction, it will send requests for MP3 bitstream as required, and play the audio. When the audio stream is complete, the server FPGA should send a STOP command.

Operating System in Reconfigurable Logic

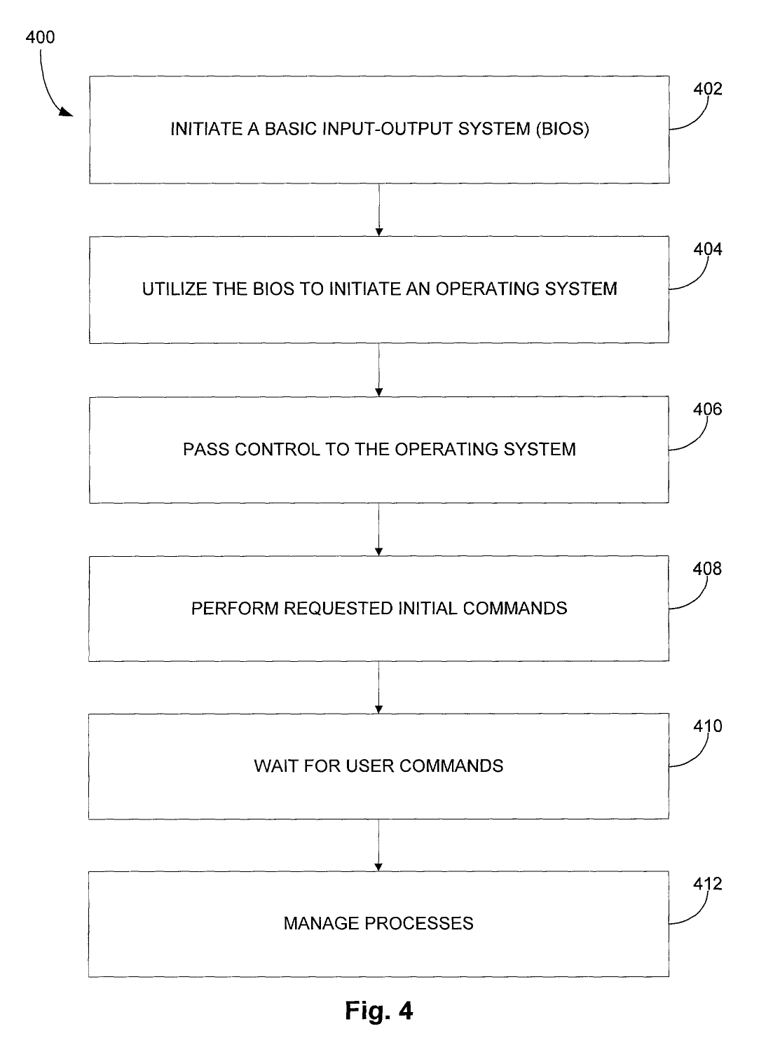

FIG. 4 illustrates a method 400 for controlling processes of a system, which can be a computer, device, etc. In operation 402, a Basic Input-Output System (BIOS) is initiated, which takes control.

In operation 404, the BIOS initiates the operating system. At least a portion, and preferably all, of the operating system is stored on a reconfigurable logic device, which preferably includes one or more FPGAs. After all operating system files have been initiated, the operating system is given control of the computer or device in operation 406. In operation 408, requested initial commands are performed. In operation 410, the operating system waits for the first interactive user input. The operating system manages one or more hardware and/or software processes, such as hardware applications, in operation 412.

In an aspect of the present invention, an optimal functionality between hardware and software of the system can be determined, and implementation of functionality between the hardware and software can be partitioned based on the determined optimal functionality.

Accordance to another embodiment of the invention, a system that utilizes an operating system stored in reconfigurable logic is provided. The system includes a reconfigurable logic device that has at least a portion, and preferably all, of an operating system stored on it. The operating system is operable to manage one or multiple hardware and/or software processes including applications.

In one embodiment of the present invention, the operating system is capable of supporting multiple processes (multitasking), and can determine an order in which the processes should run and an amount of time allowed for each process to execute before giving another process a turn. In another aspect of the present invention, the operating system is operable to manage the sharing of internal memory among multiple processes, handle input and output to and from an attached hardware device(s), such as hard disks, printers, and dial-up ports, send messages to the applications or interactive user (or to a system operator) about the status of an operation and any errors that may have occurred, and/or offload the management of what are called batch jobs (for example, printing) so that the initiating application is freed from this work.

In a preferred embodiment, the reconfigurable logic device includes one or more FPGAs. Also preferably, the reconfigurable logic device interfaces with at least one of a hardware register, buffer management, a microprocessor, an interrupt handler, and a memory transfer. A second reconfigurable logic device can be provided for reconfiguring (e.g., changing the configuration of) the first reconfigurable logic device.

In an embodiment of the present invention, the reconfigurable logic device is in communication with a code library, where the code library includes at least one driver for interfacing a hardware device or devices with an application. A driver associated with the hardware device is retrieved from the code library. The driver is utilized to configure the reconfigurable logic device to communicate with the hardware device.

This can be a dynamic process that occurs automatically upon receiving a request for access to the hardware device.

Hardware/Software Codesign

Another embodiment of the present invention provides a hardware/software codesign system which can target a system in which the hardware or the processors to run the software can be customized according to the functions partitioned to it. Thus rather than the processor or hardware being fixed (which effectively decides the partitioning), the codesign system of this invention includes a partitioning means which flexibly decides the partitioning while varying the parameters of the hardware or processor to obtain both an optimal partitioning and optimal size of hardware and processor.

In more detail it provides a codesign system for producing a target system having resources to provide specified functionality by:

(a) operation of dedicated hardware; and

(b) complementary execution of software on software-controlled machines;

The codesign system comprising means for receiving a specification of the functionality, partitioning means for partitioning implementation of the functionality between (a) and (b) and for customizing the hardware and/or the machine in accordance with the selected partitioning of the functionality.

Thus the target system is a hybrid hardware/software system. It can be formed using configurable logic resources in which case either the hardware or the processor, or both, can be formed on the configurable logic resources (e.g. an FPGA).

In one embodiment of the invention the partitioning means uses a genetic algorithm to optimize the partitioning and the parameters of the hardware and the processor. Thus, it generates a plurality of different partitions of the functionality of the target system (varying the size of the hardware and/or the processor between the different partitions) and estimates the speed and size of the resulting system. It then selects the optimal partitioning on the basis of the estimates. In the use of a genetic algorithm, a variety of partitions are randomly generated, the poor ones are rejected, and the remaining ones are modified by combining aspects of them with each other to produce different partitions. The speed and size of these are then assessed and the process can be repeated until an optimal partition is produced.

The invention is applicable to target systems which use either customizable hardware and a customizable processor, or a fixed processor and customizable hardware, or fixed hardware and a customizable processor. Thus the customizable part could be formed on an FPGA, or, for instance, an ASIC. The system may include estimators for estimating the speed and size of the hardware and the software controlled machine and may also include an interface generator for generating interfaces between the hardware and software. In that case the system may also include an estimator for estimating the size of the interface. The partitioning means calls the estimators when deciding on an optimum partitioning.

The software-controlled machine can comprise a CPU and the codesign system comprises means for generating a compiler for the CPU as well as means for describing the CPU where it is to be formed on customizable logic circuits.

The codesign system can further comprise a hardware compiler for producing from those parts of the specification partitioned to hardware a register transfer level description for configuring configurable logic resources (such as an FPGA). It can further include a synthesizer for converting the register transfer level description into a net list.

The system can include a width adjuster for setting and using a desired data word size, and this can be done at several points in the desired process as necessary.

Another aspect of the invention provides a hardware/software codesign system which receives a specification of a target system in the form of behavioral description, i.e. a description in a programming language such as can be written by a computer programmer, and partitions it and compiles it to produce hardware and software.

The partitioning means can include a parser for parsing the input behavioral description. The description can be in a familiar computer language such as C, supplemented by a plurality of predefined attributes to describe, for instance, parallel execution of processes, an obligatory partition to software or an obligatory partition to hardware. The system is preferably adapted to receive a declaration of the properties of at least one of the hardware and the software-controlled machine, preferably in an object-oriented paradigm. It can also be adapted such that some parts of the description can be at the register transfer level, to allow closer control by the user of the final performance of the target system.

Thus, in summary, the invention provides a hardware/software codesign system for making an electronic circuit which includes both dedicated hardware and software controlled resources. The codesign system receives a behavioral description of the target electronic system and automatically partitions the required functionality between hardware and software, while being able to vary the parameters (e.g. size or power) of the hardware and/or software. Thus, for instance, the hardware and the processor for the software can be formed on an FPGA, each being no bigger than is necessary to form the desired functions. The codesign system outputs a description of the required processor (which can be in the form of a net list for placement on the FPGA), machine code to run on the processor, and a net list or register transfer level description of the necessary hardware. It is possible for the user to write some parts of the description of the target system at register transfer level to give closer control over the operation of the target system, and the user can specify the processor or processors to be used, and can change, for instance, the partitioner, compilers or speed estimators used in the codesign system. The automatic partitioning can be performed by using an optimization algorithm, e.g. a genetic algorithm, which generates a partitioning based on estimates of performance.

The invention also allows the manual partition of systems across a number of hardware and software resources from a single behavioral description of the system. This provision for manual partitioning, as well as automatic partitioning, gives the system great flexibility.

The hardware resources may be a block that can implement random hardware, such as an FPGA or ASIC; a fixed processor, such as a microcontroller, DSP, processor, or processor core; or a customizable processor which is to be implemented on one of the hardware resources, such as an FPGA-based processor. The system description can be augmented with register transfer level descriptions, and parameterized instantiations of both hardware and software library components written in other languages.

The sort of target systems which can be produced include:

a fixed processor or processor core, coupled with custom hardware;

a set of customizable (e.g. FPGA-based) processors and custom hardware;

a system on a chip containing fixed processors and an FPGA; and

a PC containing an FPGA accelerator board.

The use of the advanced estimation techniques in specific embodiments of the invention allows the system to take into account the area of the processor that will be produced, allowing the targeting of customizable processors with additional and removable instructions, for example. The estimators also take into account the speed degradation produced when the logic that a fixed hardware resource must implement nears the resource's size limit. This is done by the estimator reducing the estimated speed as that limit is reached. Further, the estimators can operate on both the design before partitioning, and after partitioning. Thus high level simulation, as well as simulation and estimation after partitioning, can be performed.

Where the system is based on object oriented design, this allows the user to add new processors quickly and to easily define their compilers.

The part of the system which compiles the software can transparently support additional or absent instructions for the processor and so is compatible with the parameterization of the processor.

Preferably, the input language supports variables with arbitrary widths, which are then unified to a fixed width using a promotion scheme, and then mapped to the widths available on the target system architecture.

Further in one embodiment of the invention it is possible for the input description to include both behavioral and register transfer level descriptions, which can both be compiled to software. This gives support for very fast simulation and allows the user control of the behavior of the hardware on each clock cycle.

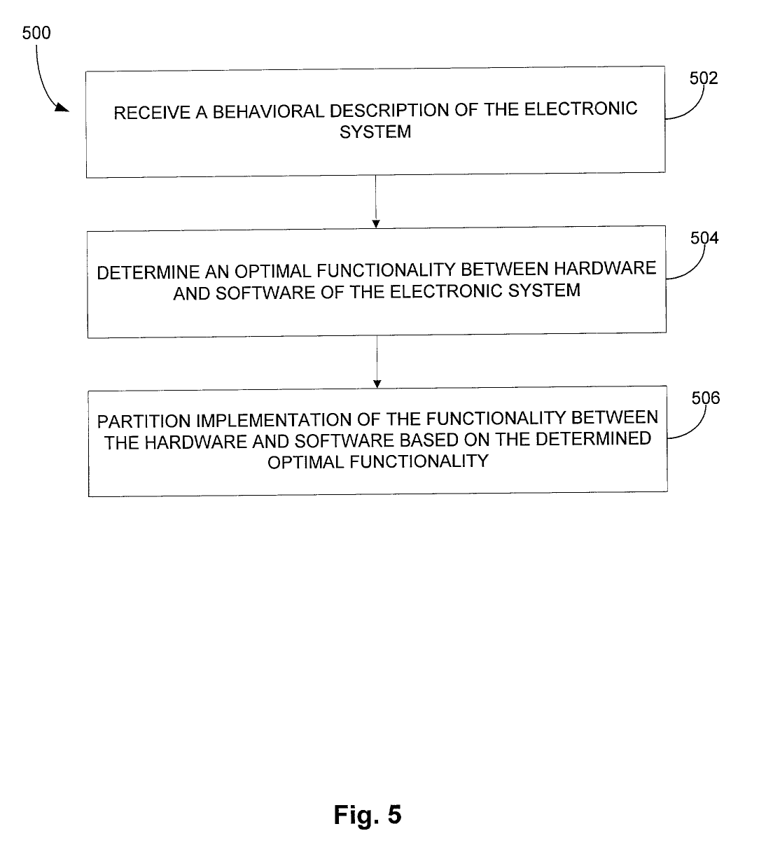

FIG. 5 is a flow diagram of a process 500 for automatically partitioning a behavioral description of an electronic system into the optimal configuration of hardware and software according to a preferred embodiment of the present invention. In operation 502, the system receives a behavioral description of the electronic system and, in operation 504, determines the optimal required functionality between hardware and software. In operation 506, that functionality is partitioned preferably while varying the parameters (e.g. size or power) of the hardware and/or software. Thus, for instance, the hardware and the processors for the software can be formed on a reconfigurable logic device, each being no bigger than is necessary to form the desired functions.

The codesign system outputs a description of the required processors, machine code to run on the processors, and a net list or register transfer level description of the necessary hardware. It is possible for the user to write some parts of the description of the system at register transfer level to give closer control over the operation of the system, and the user can specify the processor or processors to be used, and can change, for instance, the partitioner, compilers or speed estimators used in the codesign system. The automatic partitioning is formed by using a genetic algorithm which estimates the performance of randomly generated different partitions and selects an optimal one of them.

This description will later refer to specific examples of the input behavioral or register transfer level description of examples of target systems. These examples are reproduced in Appendices, namely:

Appendix 1 is an exemplary register transfer level description of a simple processor.

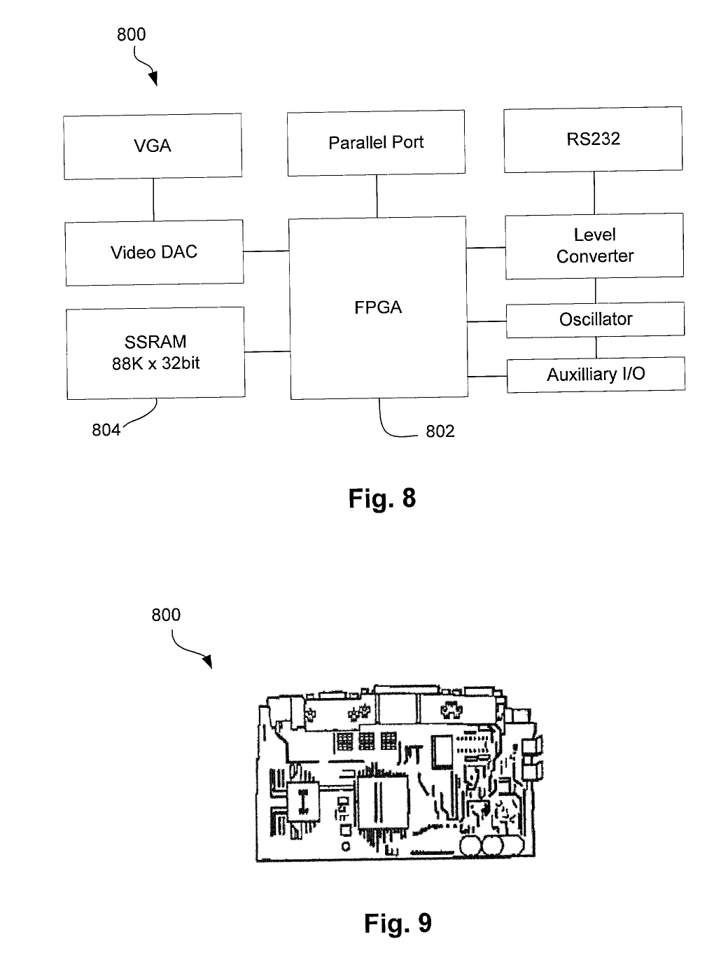

Appendix 2 is a register transfer level description of the main process flow in the example of FIGS. 8 to 10.

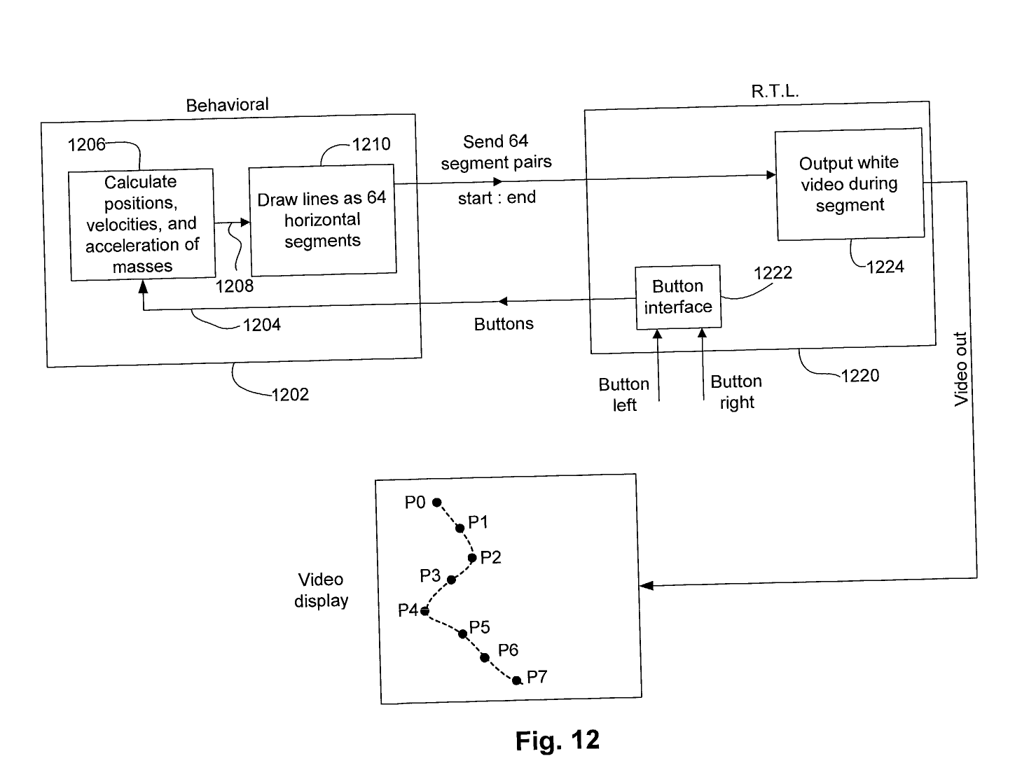

Appendix 3 is the input specification for the target system of FIG. 12.

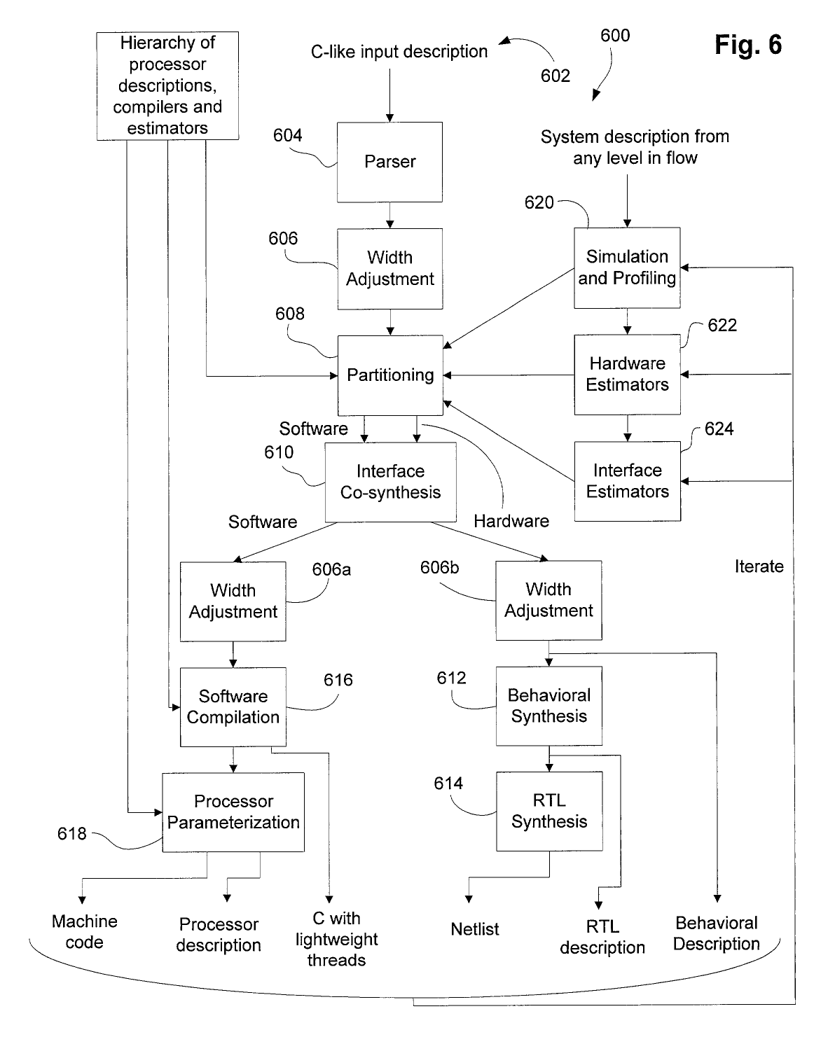

The flow of the codesign process in an embodiment of the invention is shown in FIG. 6 and will be described below. The target architecture for this system is an FPGA containing one or more processors, and custom hardware. The processors may be of different architectures, and may communicate with each other and with the custom hardware.

The Input Language

In this embodiment the user writes a description 602 of the system in a C-like language, which is actually ANSI C with some additions which allow efficient translation to hardware and parallel processes. This input description will be compiled by the system 600 of FIG. 6. The additions to the ANSI C language include the following:

Variables are declared with explicit bit widths and the operators working on the variables work with an arbitrary precision. This allows efficient implementation in hardware. For instance a statement which declares the width of variables (in this case the program counter pc, the instruction register ir, and the top of stack tos) is as follows:

unsigned 12 pc, ir, tos

The width of the data path of the processor in the target system may be declared, or else is calculated by the partitioner 608 as the width of the widest variable which it uses.

The “par” statement has been added to describe process-level parallelism. The system can automatically extract fine-grained parallelism from the C-like description but generating coarse-grained parallelism automatically is far more difficult. Consequently the invention provides this attribute to allow the user to express parallelism in the input language using the “par” statement which specifies that a following list of statements is to be executed in parallel. For example, the expression:

Par {
parallel_port(port);
SyncGeno;
}

means that two sub-routines, the first of which is a driver for a parallel port and the second of which is a sync generator for a video display are to be executed in parallel. All parts of the system will react to this appropriately.

Channels can be declared and are used for blocking, point-to-point synchronized communication as used in occam (see G. Jones. Programming in occam. Prentice Hall International Series in Computer Science, 1987, which is hereby incorporated by reference ) with a syntax like a C function call. The parallel processes can use the channels to perform distributed assignment. Thus parallel processes can communicate using blocking channel communication. The keyword “chan” I declares these channels. For example,

chan hwswchan; i I

declares a channel along which variables will be sent and received between the hardware and software parts of the system. Further,

send (channel 1, a)

is a statement which sends the value of variable a down channel 1; and receive (channel 2, b) is a statement which assigns the value received along channel 2 to variable b.

The hardware resources available are declared. The resources may be a customizable processor, a fixed processor, or custom hardware. The custom hardware may be of a specific architecture, such as a Xilinx FPGA. Further, the architecture of the target system can be described in terms of the available functional units and their interconnection.

To define the architecture “platforms” and “channels” are defined. A platform can be hard or soft. A hard platform is something that is fixed such as a Pentium processor or an FPGA. A soft platform is something that can be configured like an FPGA-based processor. The partitioner 608 understands the keywords “hard” and “soft”, which are used for declaring these platforms and the code can be implemented on any of these.

This particular embodiment supports the following hard platforms:

Xilinx 4000 series FPGAs (e.g. the Xilinx 4085 below);

Xilinx Virtex series FPGAs;

Altera Flex and APEX PLDs;

Processor architectures supported by ANSI C compilers;

and the following soft platforms each of which is associated with one of the parameterizable processors mentioned later:

FPGAStackProc, FPGAParallelStackProc, FPGAMips.

An attribute can be attached to a platform when it is declared:

platform (PLATFORMS) y t c

For a hard platform the attribute PLATFORMS contains one element: the architecture of the hard platform. In this embodiment this may be the name of a Xilinx 3000 or 4000 series FPGA, an Altera FPGA, or an x86 processor.

For a soft platform, PLATFORMS is a pair. The first element is the architecture of the platform:

FPGAStackProc, FPGAParallelStackProc or FPGAMips

and the second is the name of the previously declared platform on which the new platform is implemented.

Channels can be declared with an implementation, and as only being able to link previously declared platforms. The system 600 recognizes the following channel implementations:

PCIBus—a channel implemented over a PCI bus between an FPGA card and a PC host.

FPGAChan—a channel implemented using wires on the FPGA.

The following are the attributes which can be attached to a channel when it is declared:

type (CHANNELTYPE)

This declares the implementation of the channel. Currently CHANNELTYPE may be PCIBus or FPGAChan. FPGAChan is the default.

from (PLATFORM)

PLATFORM is the name of the platform which can send down the channel.

to (PLATFORM)

PLATFORM is the name of the platform which can receive from the channel.

The system 600 checks that the declared channels and the platforms that use them are compatible. The communication mechanisms which a given type of channel can implement are built into the system. New mechanisms can be added by the user, in a similar way to adding new processors as will be explained below.

Now an example of an architecture will be given.

Example Architecture

/* Architectural Declarations */
// the 4085 is a hard platform -- call this one meetea board hard
meeteaBoard -attribute_((platform(Xilinx4085)));
// the pentium is a hard platform -- call this one hostProcessor hard
hostProcessor attribute- ((platform(Pentium)));
// proci is a soft platform which is implemented
// on the FPGA on the meetea board

| | |
|---|---|
| soft proci | attribute- ((platform(FpgaStackProc, meeteaBoard))); |

Example Program

void main()

{

// channell is implemented on a PCIBus

I

// and can send data from hostProcessor to meetea board
chan channel1 attribute- ((type(PCIBus), from(hostProcessor),
to(meeteaBoard)));

// channel2 is implemented on the FPGA
chan channel2, attribute- ((type(FPGAChan)));
/* the code */

par {

// code which can be assigned to
// either hostProcessor (software),
// or prod (software of reconfigurable processor),
// or meetea board (hardware),
//or left unassigned (compiler decides).
// Connections between hostProcessor
// and prod or meetea must be over the PCI Bus
// (channell)
// Connections between procl and hardware
// must be over the FPGA channel (channel2)

Attributes are also added to the input code to enable the user to specify whether a block is to be put in hardware or software and for software the attribute also specifies the target processor. The attribute is the name of the target platform. For example:

{

int a, b;
a = a + b;

| | |
|---|---|
| } | attribute- ((platform(hostProcessor))) |

assigns the operation a+b to Host Processor.

For hardware the attribute also specifies whether the description is to be interpreted as a register transfer (RT) or behavioral level description. The default is behavioral. For example:

{

int a, b;
par {

b = a + b;
a b,

}

} ,attribute-((platform(meeteaBoard),level(RTL)))

would be compiled to hardware using the RTL compiler, which would guarantee that the two assignments happened on the same clock cycle.

Thus parts of the description which are to be allocated to hardware can be written by the user at a register transfer level, by using a version of the input language with a well defined timing semantics (for example Handel-C or another RTL language), or the scheduling decisions (i.e. which operations happen on which clock cycle) can be left to the compiler. Thus using these attributes a block of code may be specifically assigned by the user to one of the available resources. Soft resources may themselves be assigned to hardware resources such as an FPGA-based processor. The following are the attributes which can be attached to a block of code:

platform (PLATFORM)

PLATFORM is the name of the platform on which the code will be implemented. This implies the compiler which will be used to compile that code.

level (LEVEL)

LEVEL is Behavioral or RTL. Behavioral descriptions will be scheduled and may be partitioned. RTL descriptions are passed straight through to the RTL synthesizer e.g. a Handel-C compiler.

cycles (NUMBER)

NUMBER is a positive integer. Behavioral descriptions will be scheduled in such a way that the block of code will execute within that number of cycles, when possible. An error is generated if it is not possible.

Thus the use of this input language which is based on a known computer language, in this case C, but with the additions above allows the user, who could be a system programmer, to write a specification for the system in familiar behavioral terms like a computer program. The user only needs to learn the additions above, such as how to declare parallelism and to declare the available resources to be able to write the input description of the target system.

This input language is input to the parser 604 which parses and type checks the input code, and performs some syntax level optimizations, (in a standard way for parsers), and attaches a specific compiler to each block of code based on the attributes above. The parser 604 uses standard techniques [Aho, Sethi and Ullman; “Compilers Principles, Techniques, and Tools”; Addison Wesley known as “The Dragon Book”, which is hereby incorporated by reference] to turn the system description in the input language into an internal data structure, the abstract syntax tree which can be supplied to the partitioner 608.

The width adjuster 606 uses C-techniques to promote automatically the arguments of operators to wider widths such that they are all of the same width for instance by concatenating them with zeros. Thus this is an extension of the promotion scheme of the C language, but uses arbitrary numbers of bits. Further adjustment is carried out later in the flow at 606a and 606b, for instance by ANDing them with a bit mask. Each resource has a list of widths that it can support. For example a 32 bit processor may be able to carry out 8, 16 and 32 bit operations. Hardware may be able to support any width, or a fixed width datapath operator may have been instantiated from a library. The later width adjustment modules 606a and 606b insert commands to enable the width of operation in the description to be implemented correctly using the resources available.

Hardware/Software Partitioning

The partitioner 608 generates a control/data-flow graph (CDFG) from the abstract syntax tree, for instance using the techniques described in G. de Michelli “Synthesis and Optimization of Digital Circuits”; McGraw-Hill, 1994 which is hereby incorporated by reference. It then operates on the parts of the description which have not already been assigned to resources by the user. It groups parts of the description together into blocks, “partitioning blocks”, which are indivisible by the partitioner. The size of these blocks is set by the user, and can be any size between a single operator, and a top-level process. Small blocks tend to lead to a slow more optimal partition; large blocks tend to lead to a faster less optimal partition.

The algorithm used in this embodiment is described below but the system is designed so that new partitioning algorithms can easily be added, and the user can choose which of these partitioning algorithms to use. The algorithms all assign each partitioning block to one of the hardware resources which has been declared.

The algorithms do this assignment so that the total estimated hardware area is smaller than the hardware resources available, and so that the estimated speed of the system is maximized.

The algorithm implemented in this embodiment of the system is a genetic algorithm for instance as explained in D. E. Goldberg, “Genetic Algorithms in Search, Optimization and Machine learning”, Addison-Wesley, 1989 which is hereby incorporated by reference. The resource on which each partitioning block is to be placed represents a gene and the fitness function returns infinity for a partitioning which the estimators say will not fit in the available hardware; otherwise it returns the estimated system speed. Different partitions are generated and estimated speed found. The user may set the termination condition to one of the following:

1) when the estimated system speed meets a given constraint;

2) when the result converges, i.e. the algorithm has not resulted in improvement after a user-specified number of iterations;

3) when the user terminates the optimization manually.

The partitioner 608 uses estimators 620, 622, and 624 to estimate the size and speed of the hardware, software and interfaces as described below.

It should be noted from FIG. 6 that the estimators and the simulation and profiling module 620 can accept a system description from any level in the flow. Thus it is possible for the input description, which may include behavioral and register transfer level parts, to be compiled to software for simulation and estimation at this stage. Further, the simulator can be used to collect profiling information for sets of typical input data, which will be used by the partitioner 608 to estimate data dependent values, by inserting data gathering operations into the output code.

Hardware Estimation

The estimator 622 is called by the partitioner 608 for a quick estimation of the size and speed of the hardware parts of the system using each partition being considered. Data dependent values are estimated using the average of the values for the sets of typical input data supplied by the user.

To estimate the speed of hardware, the description is scheduled using a call to the behavioral synthesizer 612. The user can choose which estimation algorithm to use, which gives a choice between slow accurate estimation and faster less accurate estimation. The speed and area of the resulting RTL level description is then estimated using standard techniques. For FPGAs the estimate of the speed is then decreased by a non-linear factor determined from the available free area, to take into account the slower speed of FPGA designs when the FPGA is nearly full.

Software Estimation

If the software is to be implemented on a fixed processor, then its speed is estimated using the techniques described in J. Madsen and J. Grode and P. V. Knudsen and M. E. Petersen and A. I-Iaxthausen, “LYCOS: the Lyngby Co-Synthesis System, Design Automation of Embedded Systems, 1977, volume 2, number 2, (Madsen et al) which is hereby incorporated by reference. The area of software to be implemented on a fixed processor is zero.

If the target is customizable processors to be compiled by the system itself then a more accurate estimation of the software speed is used which models the optimizations that the software compiler 616 uses. The area and cycle time of the processor is modeled using a function which is written for each processor, and expresses the required values in terms of the values of the processor's parameterizations, such as the set of instructions that will be used, the data path and instruction register width and the cache size.

Interface Synthesis and Estimation

Interfaces between the hardware and software are instantiated by the interface cosynthesizer 610 from a standard library of available communication mechanisms. Each communication mechanism is associated with an estimation function, which is used by the partitioner to cost the software and hardware speed and area required for given communication, or set of communications. Interfaces which are to be implemented using a resource which can be parameterized (such as a channel on an FPGA), are synthesized using the parameterizations decided by the partitioner. For example, if a transfer of ten thousand 32 bit values over a PCI bus was required, a DMA transfer from the host to an FPGA card's local memory might be used.

Compilation

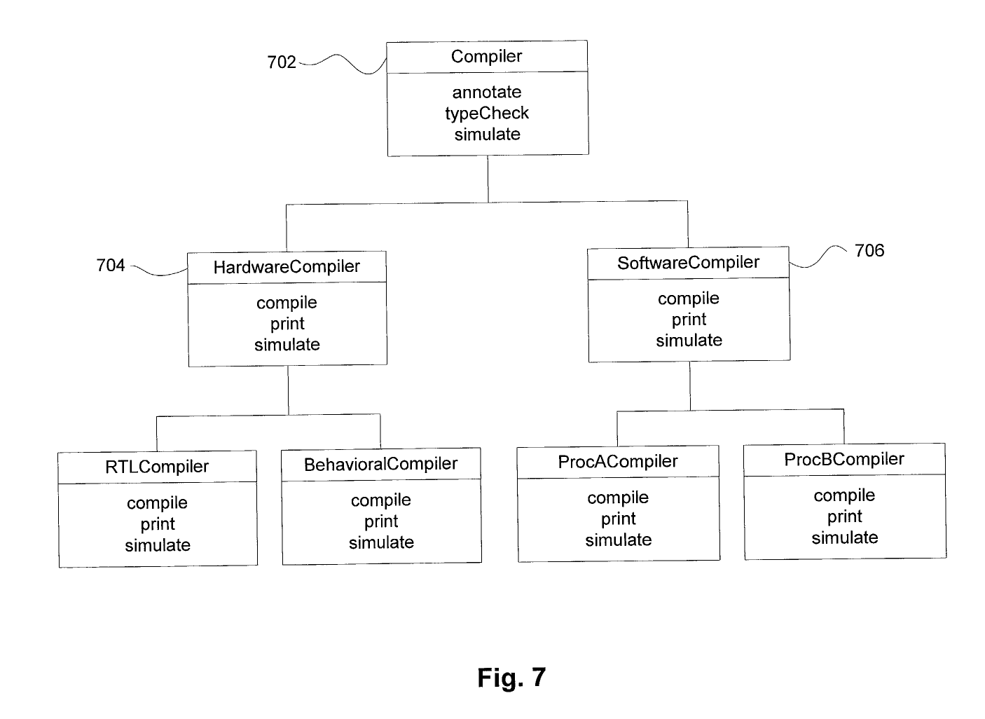

The compiler parts of the system are designed in an object oriented way, and actually provide a class hierarchy of compilers, as shown in FIG. 7. Each node in the tree shows a class which is a subclass of its parent node. The top-level compiler class 702 provides methods common to both the hardware and software flows, such as the type checking, and a system-level simulator used for compiling and simulating the high-level description. These methods are inherited by the hardware and software compilers 704, 706, and may be used or overridden. The compiler class also specifies other, virtual, functions which must be supplied by its subclasses. So the compile method on the hardware compiler class compiles the description to hardware by converting the input description to an RTL description; the compile method on the Processor A compiler compiles a description to machine code which can run on Processor A.

There are two ways in which a specific compiler can be attached to a specific block of code:

A) In command line mode. The compiler is called from the command line by the attributes mentioned above specifying which compiler to use for a block of code.

B) Interactively. An interactive environment is provided, where the user has access to a set of functions which the user can call, e.g. to estimate speed and size of hardware and software implementations, manually attach a compiler to a block of code, and call the simulator. This interactive environment also allows complex scripts, functions and macros to be written and saved by the user for instance so that the user can add a new partitioning algorithm.

The main compilation stages of the process flow are software or hardware specific. Basically at module 612 the system schedules and allocates any behavioral parts of the hardware description, and at module 616 compiles the software description to assembly code. At module 618 it also writes a parameterized description of the processors to be used, which may also have been designed by the user. These individual steps will be explained in more detail.

Hardware Compilation

The parts of the description to be compiled into hardware use a behavioral synthesis compiler 612 using the techniques of De Michelli mentioned above. The description is translated to a control/data flow graph, scheduled (i.e. what happens on each clock cycle is established) and bound (i.e. which resources are used for which operations is established), optimized, and then an RT-level description is produced.

Many designers want to have more control over the timing characteristics of their hardware implementation. Consequently the invention also allows the designer to write parts of the input description corresponding to certain hardware at the register transfer level, and so define the cycle-by-cycle behavior of that hardware.

This is done by using a known RT-level description with a well-defined timing semantics such as Handel-C. In such a description each assignment takes one clock cycle to execute, control structures add only combinational delay, and communications take one clock cycle as soon as both processes are ready. With the invention an extra statement is added to this RT-level version of the language: “delay” is a statement which uses one clock cycle but has no other effect. Further, the “par” attribute may again be used to specify statements which should be executed in parallel.

Writing the description at this level, together with the ability to define constraints for the longest combinational path in the circuit, gives the designer close control of the timing characteristics of the circuit when this is necessary. It allows, for example, closer reasoning about the correctness of programs where parallel processes write to the same variable. This extra control has a price: the program must be refined from the more general C description, and the programmer is responsible for thinking about what the program is doing on a cycle-by-cycle basis. An example of a description of a processor at this level will be discussed later.

The result of the hardware compilation by the behavioral synthesizer 612 is an RTL description which can be output to a RTL synthesis system 614 using a hardware description language (e.g. Handel-C or VHDL), or else synthesized to a gate level description using the techniques of De Michelli.

RTL synthesis optimizes the hardware description, and maps it to a given technology. This is performed using standard techniques.

Software Compilation

The software compiler 616 largely uses standard techniques [e.g. from Aho, Sethi and Ullman mentioned above]. In addition, parallelism is supported by mapping the invention's CSP-like model of parallelism and communication primitives into the target model. For instance channels can mapped to blocks of shared memory protected by semaphores. CSP is described in C. A. R. Hoare “Communicating sequential processes.” Prentice-Hall International series in computing science. Prentice-Hall International, Englewood Cliffs, N.J. which is hereby incorporated by reference.

Compound operations which are not supported directly by the processor are decomposed into their constituent parts, or mapped to operations on libraries. For example multiply can be decomposed into shifts and adds. Greedy pattern matching is then used to map simple operations into any more complex instructions which are supported by the processor. Software can also be compiled to standard ANSI C, which can then be compiled using a standard compiler. Parallelism is supported by mapping the model in the input language to the model of parallelism supported by the C compiler, libraries and operating system being used.

The software compiler is organized in an object oriented way to allow users to add support for different processors (see FIG. 7) and for processor parameterizations. For example, in the processor parameterize 618 unused instructions from the processor description are automatically removed, and support for additional instructions can be added. This embodiment of the invention, includes some prewritten processor descriptions which can be selected by the user. It contains parameterized descriptions of three processors, and the software architecture is designed so that it is easy for developers to add new descriptions which can be completely new or refinements of these. The three processors provided are

A Mips-like processor, similar to that described in [Patterson and Hennessy, Computer Organization and Design, 2″d Edition, Morgan Kauffman].

A 2-cycle non-pipelined stack-based processor (see below).

A more sophisticated multicycle non-pipelined stack-based processor, with a variable number of cycles per instruction, and hardware support for parallelism and channels.

Thus the software compiler supports many processor parameterizations. More complex and unexpected modifications are supported by virtue of the object oriented design of the compiler, which allows small additions to be made easily by the user. Most of the mapping functions can be inherited from existing processor objects, minor additions can be made a function used to calculate the speed and area of processor given the parameterizations of the processor and a given program.

The output of the software compilation/processor parameterization process is machine code to run on the processor together with a description of the processor to be used (if it is not a standard one).

Co-simulation and Estimation

The scheduled hardware, register transfer level hardware, software and processor descriptions are then combined. This allows a cycle-accurate co-simulation to be carried out, e.g. using the known Handel-C simulator, though a standard VHDL or Verilog simulator and compiler could be used.

Handel-C provides estimation of the speed and area of the design, which is written as an HTML file to be viewed using a standard browser, such as Netscape. The file shows two versions of the program: in one each statement is colored according to how much area it occupies, and in the other according to how much combinational delay it generates. The brighter the color for each statement, the greater the area or delay. This provides a quick visual feedback to the user of the consequences of design decisions.

The Handel-C simulator is a fast cycle-accurate simulator which uses the C-like nature of the specification to produce an executable which simulates the design. It has an X-windows interface which allows the user to view VGA video output at about one frame per second.

When the user is happy with the RT-level simulation and the design estimates then the design can be compiled to a netlist. This is then mapped, placed and routed using the FPGA vendor's tools.

The simulator can be used to collect profiling information for sets of typical input data, which will be used by the partitioner 608 to estimate data dependent values, by inserting data gathering operations into the output code.

Implementation Language

The above embodiment of the system was written in objective CAML which is a strongly typed functional programming language which is a version of ML but obviously it could be written in other languages such as C.

Provable Correctness

A subset of the above system could be used to provide a provably correct compilation strategy. This subset would include the channel communication and parallelism of OCCAM and CSP. A formal semantics of the language could be used together with a set of transformations and a mathematician, to develop a provably correct partitioning and compilation route.

Some examples of target systems designed using the invention will now be described.

### EXAMPLE 1

Processor Design

The description of the processor to be used to run the software part of the target system may itself be written in the C-like input language and compiled using the codesign system. As it is such an important element of the final design most users will want to write it at the register transfer level, in order to hand-craft important parts of the design. Alternatively the user may use the predefined processors, provided by the codesign system or write the description in VHDL or even at gate level, and merge it into the design using an FPGA vendor's tools.

With this system the user can parameterize the processor design in nearly any way that he or she wishes as discussed above in connection with the software compilation and as detailed below.

The first processor parameterization to consider is removing redundant logic. Unused instructions can be removed, along with unused resources, such as the floating point unit or expression stack.

The second parameterization is to add resources. Extra RAMS and ROMs can be added. The instruction set can be extended from user assigned instruction definitions. Power-on bootstrap facilities can be added.

The third parameterization is to tune the size of the used resources. The bit widths of the program counter, stack pointer, general registers and the opcode and operand portions of the instruction register can be set. The size of internal memory and of the stack or stacks can be set, the number and priorities of interrupts can be defined, and channels needed to communicate with external resources can be added. This freedom to add communication channels is a great benefit of codesign using a parametrizable processor, as the bandwidth between hardware and software can be changed to suit the application and hardware/software partitioning.

Finally, the assignment of opcodes can be made, and instruction decoding rearranged.

The user may think of other parameterizations, and the object oriented processor description allows this. The description of a very simple stack-based processor in this style (which is actually one of the pre-written processors provided by the codesign system for use by the user) is listed in Appendix 1.

Referring to Appendix 1, the processor starts with a definition of the instruction width, and the width of the internal memory and stack addresses. This is followed by an assignment of the processor opcodes. Next the registers are defined; the declaration “unsigned x y, z” declares unsigned integers y and z of width x. The program counter, instruction register and top-of-stack are the instruction width; the stack pointer is the width of the stack.

After these declarations the processor is defined. This is a simple non-pipelined two-cycle processor. On the first cycle (the first three-line “par”), the next instruction is fetched from memory, the program counter is incremented, and the top of the stack is saved. On the second cycle the instruction is decoded and executed. In this simple example a big switch statement selects the fragment of code which is to be executed.

This simple example illustrates a number of points. Various parameters, such as the width of registers and the depth of the stack can be set. Instructions can be added by including extra cases in the switch statement. Unused instructions and resources can be deleted, and opcodes can be assigned.

The example also introduces a few other features of the register transfer level 30 language such as rom and ram declarations.

### EXAMPLE 2

Video Game

To illustrate the use of the invention using an application which is small enough to describe easily a simple Internet video game was designed. The target system is a video game in which the user can fly a plane over a detailed background picture. Another user can be dialed up, and the screen shows both the local plane and a plane controlled remotely by the other user. The main challenge for the design is that the system must be implemented on a single medium-sized FPGA.

Implementation Platform

The platform for this application was a generic and simple FPGA-based board. A block diagram of the board 800, a Hammond board, is shown in FIG. 8, and a graphical depiction of the board 800 is shown in FIG. 9.

The Hammond board contains a Xilinx 4000 series FPGA and 256 kb synchronous static RAM. Three buttons provide a simple input device to control the plane; alternatively a standard computer keyboard can be plugged into the board. There is a parallel port which is used to configure the FPGA, and a serial port. The board can be clocked at 20 MHz from a crystal, or from a PLL controlled by the FPGA. Three groups of four pins of the FPGA are connected to a resistor network which gives a simple digital to analogue converter, which can be used to provide 12 bit VGA video by implementing a suitable sync generator on the FPGA. Problem description and discussion The specification of the video game system is as follows:

The system must dial up an Internet service provider, and establish a connection with the remote game which will be running on a workstation.

The system must display a reconfigurable background picture.

The system must display on a VGA monitor a picture of two planes: the local plane and the remote plane. The position of the local plane will be controlled by the buttons on the Hammond board.

The position of the remote plane will be received over the dialup connection every time it changes.

The position of the local plane will be sent over the dialup, connection every time it changes.

This simple problem combines some hard timing constraints, such as sending a stream of video to the monitor, with some complex tasks without timing constraints, such as connecting to the Internet service provider. There is also an illustration of contention for a shared resource, which will be discussed later.

System Design

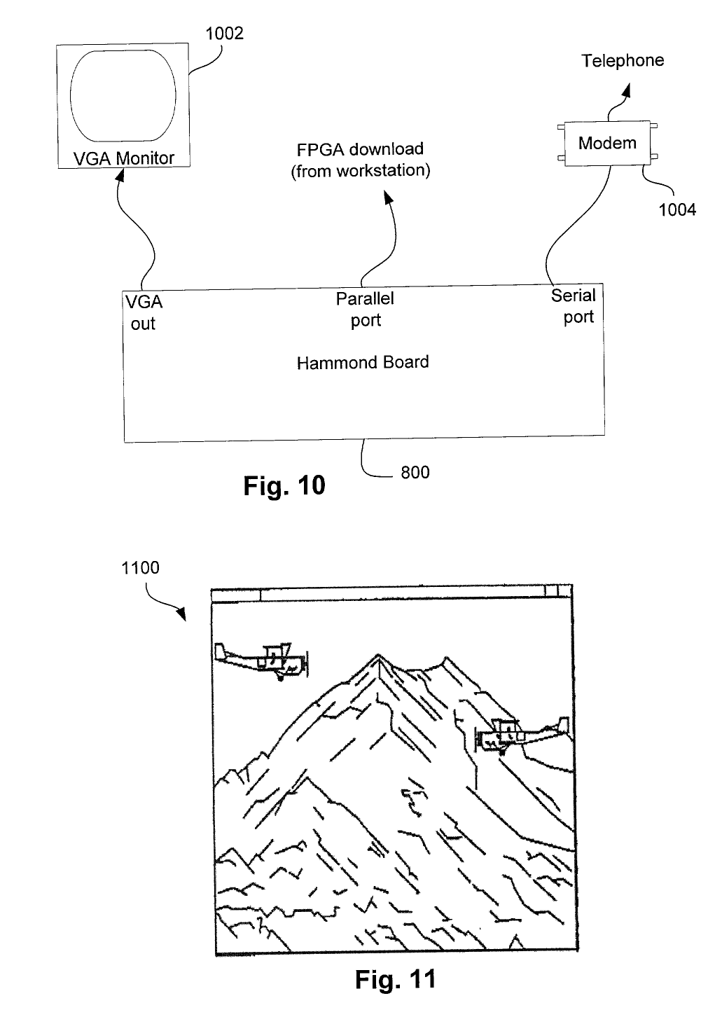

A block diagram of the system 1000 is shown in FIG. 10. The system design decisions were quite straightforward. A VGA monitor 1002 is plugged straight into the Hammond board 800. To avoid the need to make an electrical connection to the telephone network a modem 1004 can be used, and plugged into the serial port of the Hammond board. Otherwise it is quite feasible to build a simple modem in the FPGA.

The subsystems required are:

serial port interface,

dial up,

establishing the network connection,

sending the position of the local plane,

receiving the position of the remote plane,

displaying the background picture,

displaying the planes.

A simple way of generating the video is to build a sync generator in the FPGA, and calculate and output each pixel of VGA video at the pixel rate. The background picture can be stored in a “picture RAM”. The planes can be stored. As a set of 8×8 characters in a 'character generator ROM”, and the contents of each of the characters′ positions on the screen stored in a “character location RAM.

Hardware/software Partitioning

The hardware portions of the design are dictated by the need of some part of the system to meet tight timing constraints. These are the video generation circuitry and the port drivers. Consequently these were allocated to hardware, and their C descriptions written at register transfer level to enable them to meet the timing constraints. The picture RAM and the character generator ROM and character location RAM were all stored in the Hammond board RAM bank as the size estimators showed that there would be insufficient space on the FPGA.

The parts of the design to be implemented in software are the dial-up and negotiation, establishing the network, and communicating the plane locations. These are non-time critical, and so can be mapped to software. The program is stored in the RAM bank, as there is not space for the application code in the FPGA. The main function is shown in Appendix 2. The first two lines declare some communication channels. Then the driver for the parallel port and sync generator are started, and the RAM is initialized with the background picture, the character memory and the program memory. The parallel communicating hardware and software process are then started, communicating over a channel hwswchan. The software establishes the network connection, and then enters a loop which transmits and receives the position of the local and remote plane, and sends new positions to the display process.

Processor Design

The simple stack-based processor from Appendix 1 was parameterized in the following ways to run this software. The width of the processor was made to be 10 bits, which is sufficient to address a character on the screen in a single word. No interrupts were required, so these were removed, as were a number of unused instructions, and the internal memory.

Co-simulation

The RT-level design was simulated using the Handel-C simulator. Sample input files mimicking the expected inputs from the peripherals were prepared, and these were fed into the simulator. A black and white picture 1100 of the color display is shown in FIG. 1 (representing a snapshot of the X window drawn by the co-simulator).

The design was then placed and routed using the proprietary Xilinx tools, and successfully fit into the Xilinx 4013 FPGA on the Hammond board.

This application would not have been easy to implement without the codesign system of the invention. A hardware-only solution would not have fitted onto the FPGA; a software-only solution would not have been able to generate the video and interface with the ports at the required speed. The invention allows the functionality of the target system to be partitioned while parameterizing the processor to provide an optimal system.

Real World Complications

The codesign system was presented with an implementation challenge with this design. The processor had to access the RAM (because that is where the program was stored), whilst the hardware display process simultaneously had to access the RAM because this is where the background picture, character map and screen map were stored. This memory contention problem was made more difficult to overcome because of an implementation decision made during the design of the Hammond board: for a read cycle the synchronous static RAM which was used requires the address to be presented the cycle before the data is returned.

The display process needs to be able to access the memory without delay, because of the tight timing constraints placed on it. A semaphore is used to indicate when the display process requires the memory. In this case the processor stalls until the semaphore is lowered. On the next cycle the processor then presents to the memory the address of the next instruction, which in some cases may already have been presented once.

The designer was able to overcome this problem using the codesign system of invention because of the facility for some manual partitioning by the user and describing some parts of the design at the register transfer level to give close control over those parts. Thus while assisting the user, the system allows close control where desired.

### EXAMPLE 3

Mass-spring Simulation

Introduction

The “springs” program is a small example of a codesign programmed in the C-like language mentioned above. It performs a simulation of a simple mass-spring system, with a real time display on a monitor, and interaction via a pair of buttons.

Design

The design consists of three parts: a process computing the motion of the masses, a process rendering the positions of the masses into line segments, and a process which displays these segments and supplies the monitor with appropriate synchronization signals. The first two processes are written in a single C-like program. The display process is hard real-time and so requires a language which can control external signals at the resolution of a single clock cycle, so for this reason it is implemented using an RTL description (Handel-C in this instance).

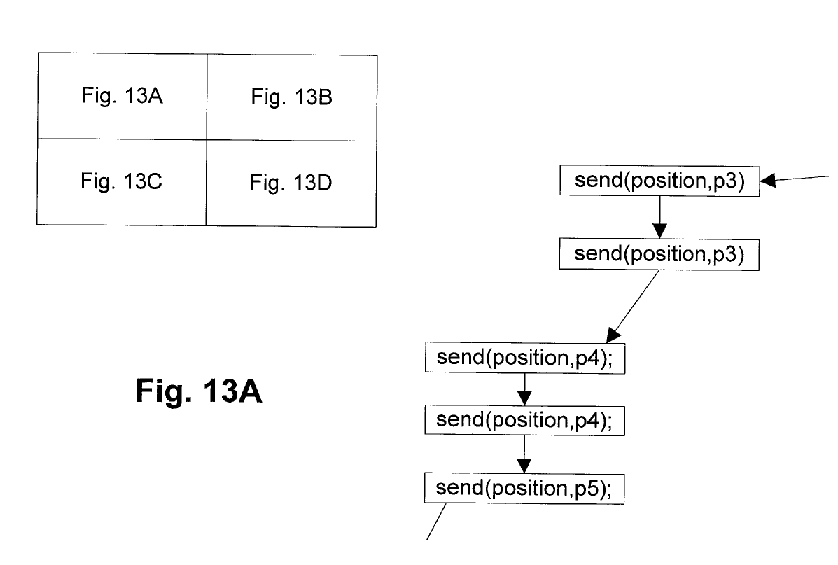

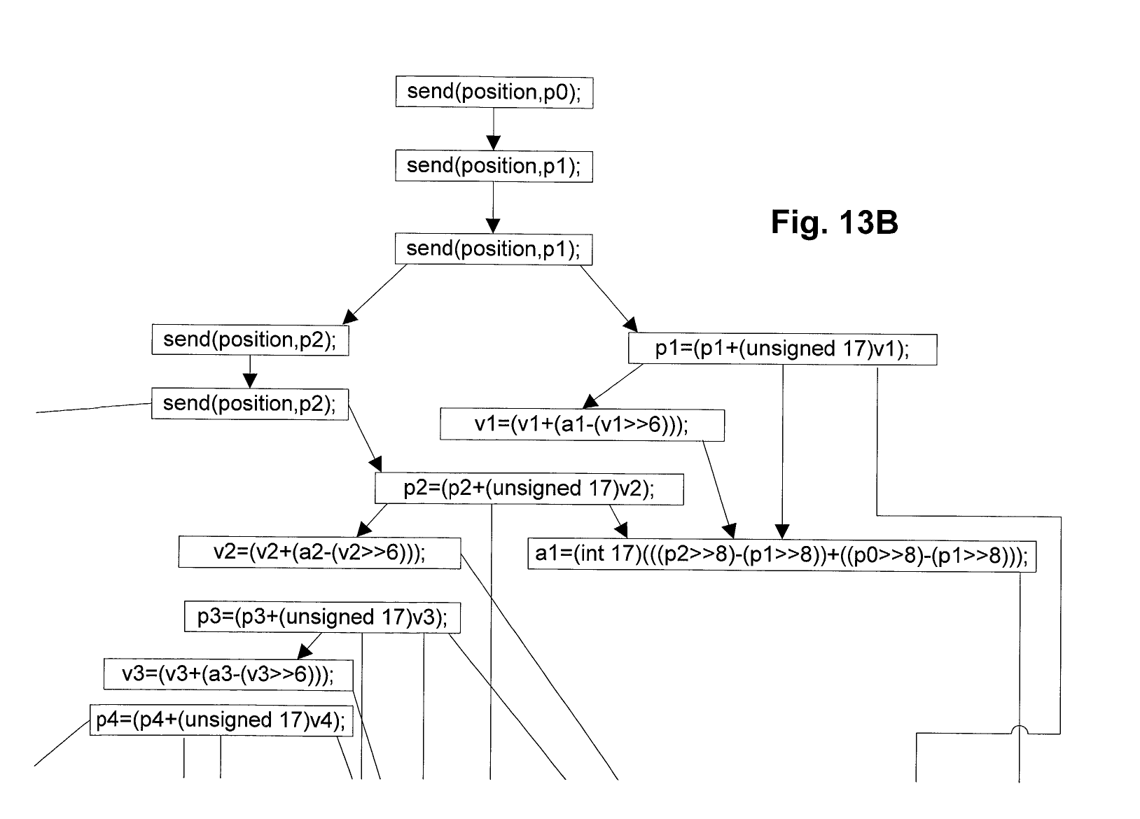

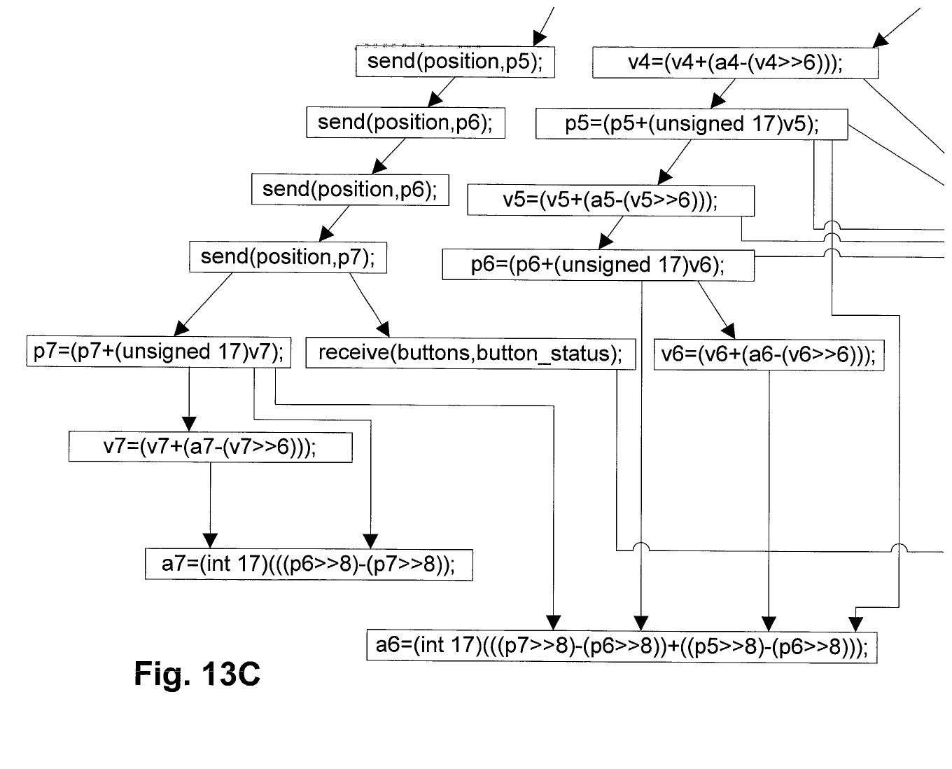

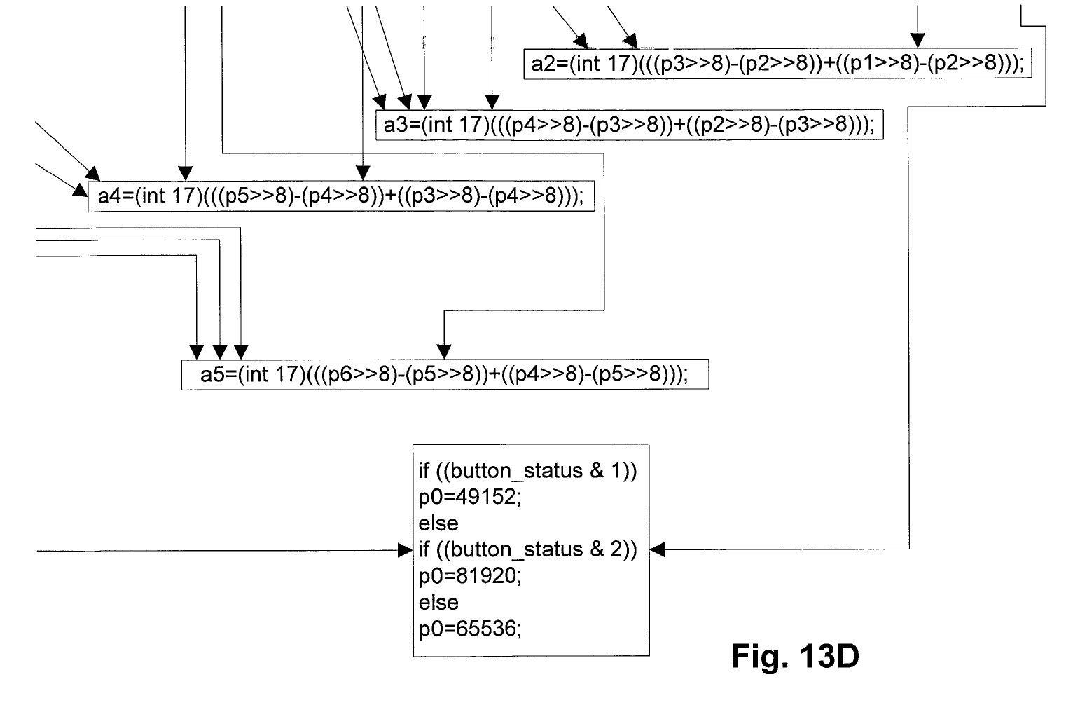

These two programs are shown in Appendix 3. They will be explained below, together with the partitioning process and the resulting implementation. FIG. 12 is a block diagram of the ultimate implementation, together with a representation of the display of the masses and springs. FIG. 13 is a dependency graph for calculation of the variables required.

Mass Motion Process

The mass motion process first sets up the initial positions, velocities and acceleration of the masses. This can be seen in Appendix 3 where positions p0 to p7 are initialized as 65536. The program then continues in an infinite loop, consisting of: sending pairs of mass positions to the rendering process, computing updated positions based on the velocities of the masses, computing updated velocities based on the accelerations of the masses, and computing accelerations based on the positions of the masses according to Hooke's law. The process then reads the status of the control buttons and sets the position of one of the masses accordingly. This can be seen in Appendix 3 as the statement “received (buttons, button status).”

This process is quite compute intensive over a short period (requiring quite a number of operations to perform the motion calculation), but since these only occur once per frame of video the amortized time available for the calculation is quite long.

Rendering Process

The rendering process runs an infinite loop performing the following operations: reading a pair of mass positions from the mass motion process then interpolate in between these two positions for the next 64 lines of video output. A pair of interpolated positions is sent to the R T L display process once per line. This is a relatively simple process with only one calculation, but this must be performed very regularly.

Display Process

The display process (which is written in Handel-C) and is illustrated in Appendix 3 reads start and end positions from the rendering process and drives the video color signal between these positions on a scan line. Simultaneously, it drives the synchronization signals for the monitor. At the end of each frame it reads the values from the external buttons and sends these to the mass motion process.

Partitioning by the Codesign System

The design could be partitioned it in a large number of ways. It could partition the entire design into hardware or into software, partition the design at the high-level, by the first two processes described above and compiling them using one of the possible routes, or it can partition the design at a lower level, and generate further parallel processes communicating with each other. Whatever choice the partitioner makes, it maintains the functional correctness of the design, but will change the cost of the implementation (in terms of the area, clock cycles and so forth). The user may direct the partitioner to choose one of the options above the others. A number of the options are described below.

Pure Hardware

The partitioner could map the first two processes directly into Handel-C, after performing some additional parallelization. The problem with this approach is that each one of the operations in the mass motion process will be dedicated to its own piece of hardware, in an effort to increase performance. However, as discussed above, this is unnecessary as these calculations can be performed at a slower speed. The result is a design that can perform quickly enough but which is too large to fit on a single FPGA. This problem would be recognized by the partitioner using its area estimation techniques.

Pure Software

An alternative approach is for the partitioner to map the two processes into software running on a parameterized threaded processor. This reduces the area required, since the repeated operations of the mass motion calculations are performed with a single operation inside the processor. However, since the processor must swap between doing the mass motion calculations and the rendering calculations, overhead is introduced which causes it to run too slowly to display in real-time. The partitioner can recognize this by using the speed estimator, based on the profiling information gathered from simulations of the system.

Software/software

Another alternative would be for the partitioner to generate a pair of parameterized processors running in parallel, the first calculating motion and the second performing the rendering. The area required is still smaller than the pure hardware approach, and the speed is now sufficient to implement the system in real time. However, using a parameterized processor for the rendering process adds some overhead (for instance, performing the instruction decoding), which is unnecessary. So although the solution works, it is a sub optimal.

Hardware/software

The best solution, and the one chosen by the partitioner, is to partition the mass motion process into software for a parameterized, unthreaded processor, and to partition the rendering process 1210 which was written at a behavioral level together with the position, velocity and acceleration calculations 1206 into hardware. This solution has the minimum area of the options considered, and performs sufficiently quickly to satisfy the real time display process.

Thus referring to FIG. 12, the behavioral part of the system 1202 includes the calculation of the positions, velocities and accelerations of the masses at 1206 (which will subsequently be partitioned to software), and the line and drawing processes at 1210 (which will subsequently be partitioned to hardware). The RTL hardware 1220 is used to receive the input from the buttons at 1222 and output the video at 1224.

Thus the partitioner 608 used the estimators 620, 622 and 624 to estimate the speed and area of each possible partition based on the use of a customized processor. The interface cosynthesizer 610 implements the interface between hardware and software on two FPGA channels 1204 and 1208 and these are used to transfer a position information to the rendering process and to transfer the button information to the position calculation 1206 from button input 1222.

The width adjuster 606, which is working on the mass motion part of the problem to be partitioned to software, parameterizes the processor to have a width of 17 bits and adjusts the width of “curr_pos” which is the current position to nine bits, the width of the segment channel. The processor parameterize at 17 further parameterizes the processor by removing unused instructions such as multiply, interrupts, and the data memory is reduced and multi-threading is removed. Further, op codes are assigned and the operator width is adjusted.

The description of the video output 1224 and button interface 1222 were, in this case, written in an R T L language, so there is no behavioral synthesis to be done for them. Further, because the hardware will be formed on an FPGA, no width adjustment is necessary because the width can be set as desired.

The partitioner 608 generates a dependency graph as shown in FIG. 13 which indicates which variables depend on which. It is used by the partitioner to determine the communications costs associated with the partitioning, for instance to assess the need for variables to be passed from one resource to another given a particular partitioning.

Thus the codesign system of the invention has the following advantages in designing a target system:

1. It uses parameterization and instruction addition and removal for optimal processor design in on FPGA. The system provides an environment in which an FPGA-based processor and its compiler can be developed in a single framework.

2. It can generate designs containing multiple communicating processors. parameterized custom processors, and the inter-processor communication can be tuned for the application.

3. The hardware can be designed to run in parallel with the processors to meet speed constraints. Thus time critical parts of the system can be allocated to custom hardware, which can be designed at the behavioral or register transfer level.

4. Non-time critical parts of the design can be allocated to software, and run on a small, slow processor.

5. The system can target circuitry on dynamic FPGAs. The FPGA can contain a small processor which can configure and reconfigure the rest of the FPGA at run time.

6. The system allows the user to explore efficient system implementations, by allowing parameterized application-specific processors with user-defined instructions to communicate with custom hardware. This combination of custom processor and custom hardware allows a very large design space to be explored by the user.

Resource Management

An embodiment of the present invention provides a resource-sharing server for allowing multiple Field Programmable Gate Arrays (FPGAs) on a computer board to access all the available hardware concurrently.

As one of the key features of the board according to an embodiment of the present invention is its ability to reconfigure itself both from Flash and over the Ethernet, it becomes apparent that there is a natural division of the roles of two FPGAs. One (the server, or FP0) should have access to the Flash and the Network and include the reconfiguration device driver. The other (the client application or FP 1) then has control over the LCD, touchscreen and the audio chip.

In a process for managing the resources of a system according to one embodiment of the present invention, the resources comprise any resource that is shared between multiple logic devices such as shared memory banks and shared Input/Output or other peripherals such as audio hardware. According to the process, a communications driver is utilized to allow at least two FPGAs to send messages to each other. An identification code is included with each message between the FPGAs, where a first portion of the identification code identifies a type of the message and a second portion of the identification code identifies a request for a resource. The identification code is processed. A macro procedure is called and is based on the type of message and the identification of the request for the resource. The macro procedure receives and processes the message.

A server according to a preferred embodiment of the present invention includes a bi-directional 16 bit communications driver for allowing the two FPGAs to talk to each other. Every message from one FPGA to the other is preceded by a 16 bit ID, the high eight bits of which identify the type of message (AUDIO, FLASH, RECONFIGURATION etc . . . ) and the low identify the particular request for that hardware (FLASH_READ etc . . . ). The id codes are processed in the header file fp0server.h, and then an appropriate macro procedure is called for each type of message (e.g. for AUDIO AudioRequest is called) which then receives and processes the main body of the communication.

Preferably, the FPGAs are allowed to access external memory. Also preferably, arbitration is provided for preventing conflicts between the FPGAs when the FPGAs access the same resource. Further, the need to stop and reinitialize drivers and hardware when passing from one FPGA to the other is removed.

As an option, shared resources can be locked from other processes while communications are in progress. This can include communications between the FPGAs and/or communication between an FPGA and the resource.

In one embodiment of the present invention, an application on one of the FPGAs is allowed to send a command to another of the FPGAs. In another embodiment of the present invention, one or more of the FPGAs is reconfigured so that it can access the resource.

In use, the server process requires a number of parameters to be passed to it. These are:

PID: Used for locking shared resources (such as the FLASH) from other processes while communications are in progress.

usendCommand, uSendLock: A channel allowing applications on FP0 to send commands to applications on FP1 and a one-bit locking variable to ensure the data is not interleaved with server-sent data.

uSoundOut, uSoundIn: Two channels mirroring the function of the audio driver. Data sent to uSoundOut will be played (assuming the correct code in FP1) out of the MMT2000 speakers, and data read from uSoundIn is the input to the MMT2000 microphone. The channels are implemented in such a way that when the sound driver blocks, the communication channel between FPGAs is not held up.

MP3Run: A one bit variable controlling the MP3 GUI. The server will activate or deactivate the MP3 GUI on receipt of commands from FP1.

ConfigAddr: A 23 bit channel controlling the reconfiguration process. When the flash address of a valid FPGA bitfile is sent to this channel, the server reconfigures FP1 with the bitmap specified.

The data transfer rate between the two FPGAs in either direction is preferably about 16 bits per 5 clock cycles (in the clock domain of the slowest FPGA), for communicating between FPGAs that may be running at different clock rates.

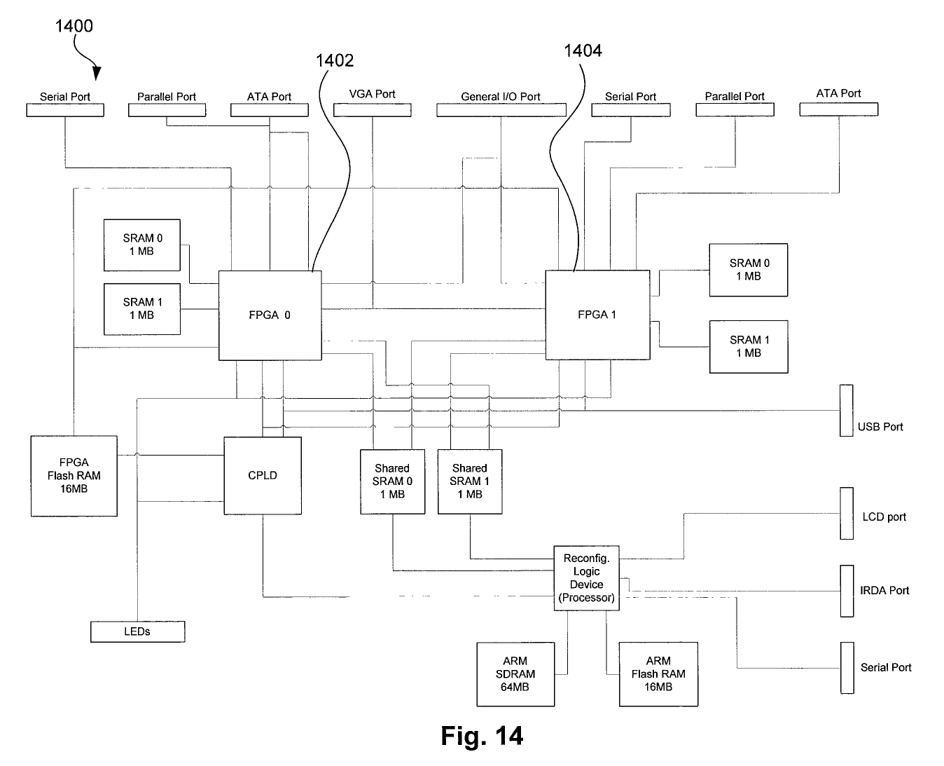

FIG. 14 is a diagrammatic overview of a board 1400 of the resource management device according to an illustrative embodiment of the present invention. It should be noted that the following description is set forth as an illustrative embodiment of the present invention and, therefore, the various embodiments of the present invention should not be limited by this description. As shown, the board can include two Xilinx Virtex™2000e FPGAs 1402, 1404, a reconfigurable logic device (which may be an FPGA) acting as the processor 1406, a large amount of memory 1408, 1410 and a number of I/O ports 1412. Its main features are listed below:

Two XCV 2000e FPGAs each with sole access to the following devices:

Two banks (1 MB each) of SRAM (256K×32 bits wide)

Parallel port

Serial port

ATA port

The FPGAs share the following devices:

VGA monitor port

Eight LEDs

2 banks of shared SRAM (also shared with the CPU)

USB interface (also shared with the CPU)

The FPGAs are connected to each other through a General Purpose I/O (GPIO) bus, a 32 bit SelectLink bus and a 32 bit Expansion bus with connectors that allow external devices to be connected to the FPGAs. The FPGAs are mapped to the memory of the reconfigurable logic device, as variable latency I/O devices.

The reconfigurable logic device emulating the processor has access to the following:

64Mbytes of SDRAM

16Mbytes of FLASH memory

LCD port

IRDA port

Serial port

It shares the USB port and the shared SRAM with the FPGAs.

In addition to these the board also has a Xilinx XC95288XL CPLD to implement a number of glue logic functions and to act as a shared RAM arbiter, variable rate clock generators and JTAG and MultiLinx SelectMAP support for FPGA configuration.

A number of communications mechanisms are possible between the reconfigurable logic device (processor) and the FPGAs. The FPGAs are mapped into the reconfigurable logic device's memory allowing them to be accessed from the reconfigurable logic device as through they were RAM devices. The FPGAs also share two 1 MB banks of SRAM with the reconfigurable logic device, allowing DMA transfers to be performed. There are also a number of direct connections between the FPGAs and the reconfigurable logic device through the reconfigurable logic devices general purpose I/O (GPIO) registers.

The board is fitted with 4 clocks, 2 fixed frequency and 2 PLLs. The PLLs are programmable by the reconfigurable logic device.

There are a variety of ways by which the FPGAs can be configured. These are:

By an external host using JTAG or MultiLinx SelectMAP

By the ARM processor, using data stored in either of the Flash RAMs or data acquired through one to the serial ports (USB, IRDA or RS232).

By the CPLD from power-up with data stored at specific locations in the FPGA FlashRAM.

By one of the other FPGAs.

Microprocessor Emulation for Use In Applications with Non Time-critical Functions

Introduction

This section describes an emulation of a microprocessor core developed in HandelC, such as emulation of an ARM6 core developed by ARM Inc., 750 University Avenue, Suite 150, Los Gatos, Calif. 95032, USA. The core may be emulated according to the methodology of the present invention set forth above, particularly in the sections entitled “Processor Module” and “Multiprocessor Embodiments.” The core is used in embedded applications, and as such can be implemented without a multiply instruction, and with user mode only.

Options

Ability to use ARMgcc to program the core

Operation up to 20 Mhz

Instructions take as few cycles as memory bandwidth permits

Operation

The emulated microprocessor core is preferably designed to be used in hardware applications with complex but non time-critical functions. In these cases a large amount of logic can be implemented as ARM software at the expense of speed. Any particularly time-critical functions can then be written in HandelC and control of these can be memory-mapped into the ARM address space.

The core is preferably designed with no knowledge of the original processor architecture and thus is not instruction cycle-perfect. Each instruction is implemented so that it takes the minimum number of clock-cycles required to access the external instruction and data memory. Thus a data-processing instruction, which uses processor registers as both input and output, only uses the one clock-cycle required to fetch the instruction. A single data transfer operation requires two cycles—one to fetch the instruction, and one to perform the appropriate memory operation.

Usage

In order to allow the core to be as flexible as possible, the core assumes nothing about the hardware on which it is running. Instead it is left to the user to define a number of macros, macro expressions and macro procedures to get the processor accessing the resources it requires. The document “Handel-C Language Reference Manual: version 3,” incorporated by reference above, provides more information about generating macros in Handel-C.

Defines

MAX_MEM_ADDR

This is set to the address of the maximum physical memory address. Memory accesses below this number will access memory, and above will access any hardware defined by the user.

Macro Expressions

macro expr ARMreadmem (addr)

This macro expression must be defined to return a 32 bit value for the ARM memory reads. An example is shown below:

macro expr ARMreadmem (a) =

(a < MAX_MEM_ADDR) ?

RAM [a] :
HardwareReg [a<−4];

Thus for all memory access below the maximum memory address, the physical ram is used. Above this address 16 different hardware registers can be read from.

Macro Procedures

macro proc ARMfastwrite (addr, val)

This macro procedure must be defined to allow accesses to the ARM memory. Generally it will be something very simple such as:

macro proc ARMfastwrite ( addr, val ) {

RAM [addr] = val;

}
macro proc ARMhardwarewrite

( addr, val )

This macro procedure is defined to allow the processor to control any external hardware, start other handelc macro procedures or anything else required. A simple example follows:

macro proc ARMhardwarewrite

( addr, val ) {
if ( addr [4] ) {

HardwareReg [addr<−4] = val;

}
else {

switch ( addr<−4 ) {

case 0:

PP1000SetLeds ( val<−8 );
break;

case 1:

RunArbitraryHardware ( val );
break;

default:

delay;
break;

}

}

}

Thus if the bit 4 of the address is set, then write to the hardware registers. Otherwise switch on the low 4 bits of the address, setting LEDs or running a macro procedure.

### Example

The emulated core can be used fully in the MP3 decoder application described above in the section entitled “MP3 Decoder Application.” In this case the hardware implemented includes a fast Huffman decoder, and two different DCT algorithms—all of which are too speed critical to run in software. The emulated core itself is used to perform a number of non-time-critical functions with many irregular memory accesses and a large amount of control logic. Had these been implemented directly in HandelC it is unlikely that the decoder would fit on a target chip and thus this is a good use of the core.

FIG. 15 illustrates a process 1500 for processing instructions of an embedded application. In operation 1052, a microprocessor is emulated in reconfigurable logic. Again, the emulation process can be similar to the processes set forth above. Control functions are implemented in reconfigurable logic in operation 1054. The emulated microprocessor processes instructions in operation 1056. Each instruction is processed in a minimum number of clock cycles required for accessing an external instruction and data memory.

In a preferred embodiment, the reconfigurable logic includes one or more Field Programmable Gate Arrays (FPGAs). Also preferably, macros are used to specify access to resources by the microprocessor. The document “Handel-C Language Reference Manual: version 3,” incorporated by reference above, provides more information about generating macros in Handel-C.

In another embodiment of the present invention, the control functions control execution of time-critical functions of the application. The time-critical functions of the application can be written in a programming language designed for compiling a programming language to programmable logic and/or in a Hardware Description Language (HDL).

Further Embodiments and Equivalents

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

[image]

[image]

[image]

[image]

[image]

[image]

[image]

[image]

[image]

[image]

[image]

[image]

[image]

[image]

What is claimed is:

1. A method for processing instructions of an embedded application, comprising the steps of:
(a) emulating a microprocessor in reconfigurable logic;
(b) implementing control functions in reconfigurable logic; and
(c) utilizing the microprocessor for processing instructions;
(d) wherein each instruction is processed in a minimum number of clock cycles required for accessing an external instruction and data memory.

2. A method as recited in claim 1, wherein the reconfigurable logic includes at least one Field Programmable Gate Array (FPGA).

3. A method as recited in claim 1, wherein macros are used to specify access to resources by the microprocessor.

4. A method as recited in claim 1, wherein the control functions control execution of time-critical functions of the application.

5. A method as recited in claim 4, wherein the time-critical functions of the application are written in a programming language designed for compiling a programming language to programmable logic.

6. A method as recited in claim 4, wherein the time-critical functions of the application are written in a Hardware Description Language (HDL).

7. A computer program product for processing instructions of an embedded application, comprising:
(a) computer code for emulating a microprocessor in reconfigurable logic;
(b) computer code for implementing control functions in reconfigurable logic; and
(c) computer code for utilizing the microprocessor for processing instructions;
(d) wherein each instruction is processed in a minimum number of clock cycles required for accessing an external instruction and data memory.

8. A computer program product as recited in claim 7, wherein the reconfigurable logic includes at least one Field Programmable Gate Array (FPGA).

9. A computer program product as recited in claim 7, wherein macros are used to specify access to resources by the microprocessor.

10. A computer program product as recited in claim 7, wherein the control functions control execution of time-critical functions of the application.

11. A computer program product as recited in claim 10, wherein the time-critical functions of the application are written in a programming language designed for compiling a programming language to programmable logic.

12. A computer program product as recited in claim 10, wherein the time-critical functions of the application are written in a Hardware Description Language (HDL).

13. A system for processing instructions of an embedded application, comprising:
(a) reconfigurable logic for emulating a microprocessor therein;
(b) reconfigurable logic for implementing control functions therein; and
(c) logic for utilizing the microprocessor for processing instructions;
(d) wherein each instruction is processed in a minimum number of clock cycles required for accessing an external instruction and data memory.

14. A system as recited in claim 13, wherein the reconfigurable logic includes at least one Field Programmable Gate Array (FPGA).

15. A system as recited in claim 13, wherein macros are used to specify access to resources by the microprocessor.

16. A system as recited in claim 13, wherein the control functions control execution of time-critical functions of the application.

17. A system as recited in claim 16, wherein the time-critical functions of the application are written in a programming language designed for compiling a programming language to programmable logic.

18. A system as recited in claim 16, wherein the time-critical functions of the application are written in a Hardware Description Language (HDL).
